(19) United States
(12) Patent Application Publication
(10) Pub. No.: US 2007/0070858 A1
(43) Pub. Date: Mar. 29, 2007

(54) Method and apparatus for recording and reproducing signal on and from optical disc

(75) Inventors: Yasuhiko Taranishi, Kanagawa-ken (JP); Toshiyuki Kato, Kanagawa-ken (JP); Hiroshi Tabata, Ibaraki-ken (JP); Kazunori Tokiwa, Tokyo-to (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/524,252

(22) Filed: Sep. 21, 2006

(30) Foreign Application Priority Data
Sep. 26, 2005 (JP) 2005-278745
Jul. 31, 2006 (JP) 2006-207687

(51) Int. Cl. G11B 7/00

(52) U.S. Cl. 369/100; 369/116; 369/121

(57) ABSTRACT

User data is recorded on a data area in first one of recording layers in a rewritable optical disc through the use of a laser beam having a power changing among different values including a first erasing power value. Test signals are recorded and reproduced on and from a section in a trial write area in the first recording layer. A region in the first recording layer is illuminated with the laser beam having a power equal to a second erasing power value to be subjected to signal erasure before the test signals are recorded and reproduced on and from the section in the trial write area. The region includes the section in the trial write area. The second erasing power value is equal to the first erasing power value multiplied by a coefficient in the range of 1.5 to 3.

### BACKGROUND OF THE INVENTION

1. Field of the Invention

This invention relates to a method and an apparatus for recording and reproducing a signal on and from an optical disc. In addition, this invention relates to an optical information recording medium such as an optical disc.

2. Description of the Related Art

Some optical information recording mediums are optical discs including DVDs (digital versatile discs) of various types such as a DVD-R (DVD-recordable) and a DVD-RW (DVD-rewritable). Some DVDs each have only a single recording layer while other DVDs each have multiple recording layers.

Regarding a typical single-layer DVD-RW, optimum power control (OPC) is implemented as follows. To record a signal on the DVD-RW, a recording laser beam modulated in accordance with the signal is applied to the DVD-RW. The quality of the recorded signal on the DVD-RW depends on the power of the laser beam applied thereto. The recording layer of the DVD-RW has a power calibration area (PCA). Test recording and reproduction (trial write and read) are performed on the DVD-RW before an information signal is recorded thereon. During the first half of the test recording and reproduction, test signals are sequentially recorded on the PCA in the DVD-RW while the power of the laser beam is changed among different values. The test signals are assigned to the different powers of the laser beam, respectively. During the second half of the test recording and reproduction, the recorded test signals are reproduced, and the reproduced test signals are evaluated. An optimum power of the laser beam is decided on the basis of the results of the evaluation of the reproduced test signals. During the recording of an information signal on the DVD-RW which follows the test recording and reproduction, the power of the laser beam is controlled at the decided optimum level.

Japanese patent application publication number 10-293926/1998 discloses a DVD-R which has a land track formed with pre-pits representing on-disc address information called LPP (land pre-pit) address information. Before the recording of information data on the DVD-R, the LPP address information is detected therefrom. During the recording of information data, the currently accessed position on the DVD-R is controlled according to the detected LPP address information.

Similarly, a DVD-RW has land pre-pits representing on-disc address information. It is known that the land pre-pits in the DVD-R or the DVD-RW represent not only the address information but also reference information about recording conditions such as a recommended recording laser power and a recommended recording laser waveform (a recommended recording strategy).

Japanese patent number 3259642 discloses a method and an apparatus for recording and reproducing a signal on and from a rewritable optical disc having a recording layer which can be changed between a crystalline state and an amorphous state depending on the power of a laser beam applied thereto. In Japanese patent 3259642, the power of the laser beam at which the recording layer changes from the crystalline state to the amorphous state to form a pit therein is referred to as the writing power (the recording power). The power of the laser beam at which the recording layer returns from the amorphous state to the crystalline state to erase a pit therefrom is referred to as the erasing power. During the recording of a new signal on the optical disc over an old recorded signal, the power of the laser beam is changed among the writing level, the erasing level, and a bottom level (a bias level). The bottom power is lower than the writing power and the erasing power. For the formation of every pit representing a portion of a newly recorded signal, the power of the laser beam is held at the erasing level for a certain interval to erase an old pit from the recording layer, and is then alternated between the writing level and the bottom level to form a new pit in the recording layer. In this case, the temporary laser power down to the bottom level prevents the unwanted diffusion of heat in the recording layer.

According to the method and the apparatus in Japanese patent 3259642, test signals are sequentially recorded on the optical disc while the writing power of the laser beam is changed among different values and the erasing power and the bottom power thereof remain fixed to certain values. The different values of the writing power are assigned to the recorded test signals, respectively. The recorded test signals are reproduced, and the reproduced test signals are evaluated through the use of characteristic parameters detected therefrom. The writing power value corresponding to optimum one among the detected characteristic parameters is decided to be optimum. One of the erasing power and the bottom power is referred to as the first power, and the other is called the second power. Thereafter, test signals are sequentially recorded on the optical disc while the writing power and the first power of the laser beam remain fixed to the optimum value and a certain value respectively and the second power thereof is changed among different values. The different values of the second power are assigned to the recorded test signals, respectively. The recorded test signals are reproduced, and the reproduced test signals are evaluated through the use of characteristic parameters detected therefrom. The second power value corresponding to optimum one among the detected characteristic parameters is decided to be optimum. Thereafter, test signals are sequentially recorded on the optical disc while the writing power and the second power of the laser beam remain fixed to the optimum values respectively and the first power thereof is changed among different values. The different values of the first power are assigned to the recorded test signals, respectively. The recorded test signals are reproduced, and the reproduced test signals are evaluated through the use of characteristic parameters detected therefrom. The first power value corresponding to optimum one among the detected characteristic parameters is decided to be optimum. As a result, the optimum writing power, the optimum erasing power, and the optimum bottom power of the laser beam are determined. During the recording of a new information signal on the optical disc over an old recorded information signal, the power of the laser beam is changed among the optimum writing level, the optimum erasing level, and the optimum bottom level. The characteristic parameters used for the evaluation of reproduced test signals are the asymmetry values, the modulation factors, the modulation-factor-derivative “γ” values, or the error rates of the reproduced signals.

In general, deciding the optimum writing power, the optimum erasing power, and the optimum bias power (the optimum bottom power) of a laser beam for a DVD-RW having multiple recording layers is more difficult than deciding those for a DVD-RW having only a single recording layer.

Characteristics of a first recording layer of a multi-layer DVD-RW which relate to signal recording and reproduction vary in accordance with the number of times of signal recording (signal rewriting) thereon. It is desirable to compensate for such a variation in the characteristics of the DVD-RW. It should be noted that the first recording layer means one among the multiple recording layers in the DVD-RW which is the closest to the optical pickup of a DVD-RW drive apparatus.

### SUMMARY OF THE INVENTION

It is a first object of this invention to provide an apparatus for recording and reproducing a signal on and from a multi-layer optical disc which can reliably compensate for a variation in recording/reproduction-related characteristics of a first recording layer of the optical disc which is caused as the number of times of signal recording thereon increases.

It is a second object of this invention to provide a method of recording and reproducing a signal on and from a multi-layer optical disc which can reliably compensate for a variation in recording/reproduction-related characteristics of a first recording layer of the optical disc which is caused as the number of times of signal recording thereon increases.

It is a third object of this invention to provide an improved optical information recording medium such as an improved optical disc.

A first aspect of this invention provides an apparatus for recording and reproducing a signal on and from a rewritable optical disc while applying a laser beam from an optical pickup to the optical disc. The optical disc has multiple recording layers among which a recording layer closest to the optical pickup is referred to as the first recording layer. The first recording layer has a data area and a trial write area. The apparatus comprises first means for recording user data on the data area in the first recording layer of the optical disc while using the laser beam having a power changing among different values including a first erasing power value; second means for recording test signals on a section in the trial write area in the first recording layer of the optical disc while using the laser beam having a power changing among different recording power values, and reproducing the recorded test signals from the section in the trial write area; and third means for performing either a first procedure or a second procedure. The first procedure illuminates a region in the first recording layer of the optical disc in an initial state with the laser beam having a power equal to a second erasing power value to implement signal erasure with respect to the region in the first recording layer before the second means records and reproduces the test signals on and from the section in the trial write area for the first time. The region includes the section in the trial write area. The second erasing power value is equal to the first erasing power value multiplied by a coefficient in the range of 1.5 to 3. The second procedure illuminates the section in the trial write area in the first recording layer of the optical disc in the initial state with the laser beam having a power equal to the second erasing power value to implement signal erasure with respect to the section in the trial write area after the second means records and reproduces the test signals on and from the section in the trial write area only once.

A second aspect of this invention provides an apparatus for recording and reproducing a signal on and from a rewritable optical disc while applying a laser beam from an optical pickup to the optical disc. The optical disc has multiple recording layers among which a recording layer closest to the optical pickup is referred to as the first recording layer. The first recording layer has a data area and a trial write area. The apparatus comprises first means for recording user data on a zone in the data area in the first recording layer of the optical disc while using the laser beam having a power changing among different values including a first erasing power value; second means for recording test signals on the trial write area in the first recording layer of the optical disc while using the laser beam having a power changing among different recording power values, and reproducing the recorded test signals from the trial write area; and third means for performing either a first procedure or a second procedure. The first procedure illuminates a prescribed region in the data area in the first recording layer of the optical disc in an initial state with the laser beam having a power equal to a second erasing power value to implement signal erasure with respect to the prescribed region in the data area before the first means records the user data on the zone in the data area for the first time. The prescribed region is a predetermined inner-circumference-side region in the data area. The predetermined inner-circumference-side region includes the zone in the data area. The second erasing power value is equal to the first erasing power value multiplied by a coefficient in the range of 1.5 to 3. The second procedure illuminates the zone in the data area in the first recording layer of the optical disc in the initial state with the laser beam having a power equal to the second erasing power value to implement signal erasure with respect to the zone in the data area after the first means records the user data on the zone in the data area only once.

A third aspect of this invention is based on the first aspect thereof, and provides an apparatus further comprising fourth means for reading out reference information representative of the coefficient from the optical disc; a memory storing reference information representative of the coefficient; fifth means for deriving the coefficient from one of (1) the reference information read out by the fourth means and (2) the reference information stored in the memory; and sixth means for deciding the second erasing power value on the basis of the first erasing power value and the coefficient derived by the fifth means.

A fourth aspect of this invention provides an optical information recording medium driven by the apparatus of the third aspect of this invention. The optical information recording medium comprises a rewritable optical disc having multiple recording layers among which a recording layer closest to an optical pickup is referred to as the first recording layer. The first recording layer has a pre-pit area and a control data zone. At least one of the pre-pit area and the control data zone prestores the reference information representative of the coefficient.

A fifth aspect of this invention provides a method of recording and reproducing a signal on and from a rewritable optical disc while applying a laser beam from an optical pickup to the optical disc. The optical disc has multiple recording layers among which a recording layer closest to the optical pickup is referred to as the first recording layer. The first recording layer has a data area and a trial write area. The method comprises the steps of (a) recording user data on the data area in the first recording layer of the optical disc while using the laser beam having a power changing among different values including a first erasing power value; (b) recording test signals on a section in the trial write area in the first recording layer of the optical disc while using the laser beam having a power changing among different recording power values, and reproducing the recorded test signals from the section in the trial write area; and (c) performing either a first procedure or a second procedure. The first procedure illuminates a region in the first recording layer of the optical disc in an initial state with the laser beam having a power equal to a second erasing power value to implement signal erasure with respect to the region in the first recording layer before the step (b) records and reproduces the test signals on and from the section in the trial write area for the first time. The region includes the section in the trial write area. The second erasing power value is equal to the first erasing power value multiplied by a coefficient in the range of 1.5 to 3. The second procedure illuminates the section in the trial write area in the first recording layer of the optical disc in the initial state with the laser beam having a power equal to the second erasing power value to implement signal erasure with respect to the section in the trial write area after the step (b) records and reproduces the test signals on and from the section in the trial write area only once.

A sixth aspect of this invention provides a method of recording and reproducing a signal on and from a rewritable optical disc while applying a laser beam from an optical pickup to the optical disc. The optical disc has multiple recording layers among which a recording layer closest to the optical pickup is referred to as the first recording layer. The first recording layer has a data area and a trial write area. The method comprises the steps of (a) recording user data on a zone in the data area in the first recording layer of the optical disc while using the laser beam having a power changing among different values including a first erasing power value; (b) recording test signals on the trial write area in the first recording layer of the optical disc while using the laser beam having a power changing among different recording power values, and reproducing the recorded test signals from the trial write area; and (c) performing either a first procedure or a second procedure. The first procedure illuminates a prescribed region in the data area in the first recording layer of the optical disc in an initial state with the laser beam having a power equal to a second erasing power value to implement signal erasure with respect to the prescribed region in the data area before the step (a) records the user data on the zone in the data area for the first time. The prescribed region is a predetermined inner-circumference-side region in the data area. The predetermined inner-circumference-side region includes the zone in the data area. The second erasing power value is equal to the first erasing power value multiplied by a coefficient in the range of 1.5 to 3. The second procedure illuminates the zone in the data area in the first recording layer of the optical disc in the initial state with the laser beam having a power equal to the second erasing power value to implement signal erasure with respect to the zone in the data area after the step (a) records the user data on the zone in the data area only once.

A seventh aspect of this invention is based on the fifth aspect thereof, and provides a method further comprising the steps of (d) reading out reference information representative of the coefficient from the optical disc; (e) deriving the coefficient from one of (1) the reference information read out by the step (d) and (2) reference information stored in a memory; and (f) deciding the second erasing power value on the basis of the first erasing power value and the coefficient derived by the step (e).

This invention has the following advantages. It is possible to compensate for a variation in recording/reproduction-related characteristics of a first recording layer of a multi-layer optical disc which is caused as the number of times of signal recording thereon increases.

### BRIEF DESCRIPTION OF THE DRAWINGS

FIG. 1 is a sectional diagram of a first prior-art DVD-RW.

FIG. 2 is a sectional diagram of a portion of the prior-art DVD-RW in FIG. 1.

FIG. 3 is a perspective view of the prior-art DVD-RW in FIG. 1.

FIG. 4 is a sectional diagram of a second prior-art DVD-RW.

FIG. 5 is a sectional view of PCAs in the prior-art DVD-RW of FIG. 4.

FIG. 6 is a time-domain diagram of the wave form of data to be recorded and the waveform of a laser beam used for data recording on a typical DVD-RW.

FIG. 7 is a diagram showing a relation between a reproduced-signal error rate and the number of times of signal recording (signal rewriting) on the prior-art DVD-RW in FIG. 4.

FIG. 8 is a diagram showing a relation among a reproduced-signal error rate, the number of times of signal recording (signal rewriting) on the prior-art DVD-RW in FIG. 4, and a writing power Pw of a laser beam.

FIG. 9 is a diagram showing a relation among a reproduced-signal error rate, the number of times of signal recording (signal rewriting) on the prior-art DVD-RW in FIG. 4, and an erasing power Pe of a laser beam.

FIG. 10 is a block diagram of an information recording and reproducing system including a host apparatus, an optical-disc drive apparatus, and an optical disc according to a first embodiment of this invention.

FIG. 11 is a block diagram of a record-condition detecting circuit in FIG. 10.

FIG. 12 is a time-domain diagram of the waveform of a DC-cut reproduced signal.

FIG. 13 is a diagram showing a typical relation between a measured modulation factor “m” and a writing power Pw of a laser beam, and a typical relation between a measured value “γ” and a writing power Pw of a laser beam.

FIG. 14 is a diagram showing a relation between a reproduced-signal asymmetry value “β” and the number of times of signal recording (signal rewriting) on an optical disc.

FIG. 15 is a diagram of the contents of a portion of one RMD block which extends from a byte position of “m” to a byte position of “m+5”.

FIG. 16 is a diagram showing the format of a portion of reference information recorded on the land pre-pits (LPP) or the control data zone in the lead-in area of an optical disc.

FIG. 17 is a diagram showing the assignment of different states of a byte in a position of “N+2” in FIG. 16 to different values of a coefficient “μ” for a recording-characteristic-improving DC erasing power of a laser beam.

FIG. 18 is a diagram showing a relation between a reproduced-signal asymmetry value “β” and the number of times of signal recording (signal rewriting) on an optical disc which has been subjected to recording-characteristic-improving DC erasure.

FIG. 19 is a diagram showing a relation among a measured asymmetry value “β”, the number of times of signal recording (signal rewriting) on an optical disc, and the DC erasing power of a laser beam used in recording-characteristic-improving DC erasure.

FIG. 20 is a flowchart of a segment of a control program for the optical-disc drive apparatus in FIG. 10.

FIG. 21 is a diagram of a pattern in which a writing power of a laser beam is changed among different values.

FIG. 22 is a flowchart of another segment of the control program for the optical-disc drive apparatus in FIG. 10.

FIG. 23 is a sectional view of R-information areas in an optical disc which are in certain conditions.

FIG. 24 is a diagram of the contents of a portion of one RMD block which extends from a byte position of “m” to a byte position of “m+5”.

FIG. 25 is a sectional view of the R-information areas in the optical disc which are in conditions different from those in FIG. 23.

FIG. 26 is a sectional view of the R-information areas in the optical disc which are in conditions different from those in FIGS. 23 and 25.

### DETAILED DESCRIPTION OF THE INVENTION

Prior-art optical discs and prior-art apparatuses will be explained below for a better understanding of this invention.

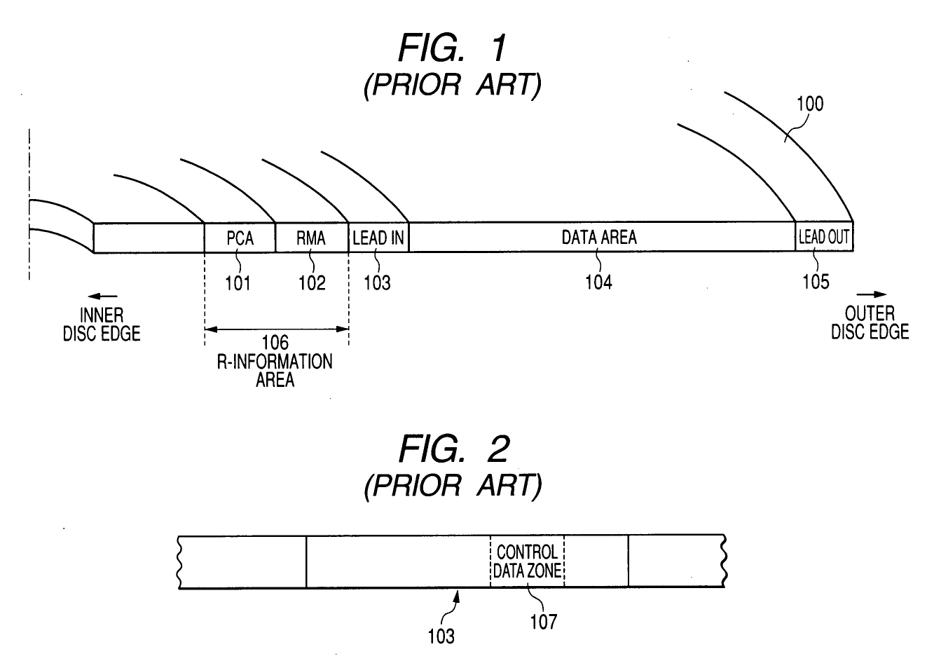

FIG. 1 shows a first prior-art DVD-RW 100. The prior-art disc 100 is of a single-recording-layer type. The prior-art disc 100 has a central opening, and thus has an inner circumferential edge in addition to an outer circumferential edge. As shown in FIG. 1, a recording area of the prior-art disc 100 is divided into a power calibration area (PCA) 101, a recording management area (RMA) 102, a lead-in area 103, a data area 104, and a lead-out area 105 which are successively arranged in that order as viewed in a radial direction from the inner disc edge toward the outer disc edge.

The PCA 101 and the RMA 102 constitute an R-information area 106. The data area 104 is assigned to user data. The lead-in area 103 and the lead-out area 105 are used as buffers for absorbing overruns of a recording and reproducing head (an optical pickup) of a prior-art optical-disc drive apparatus.

As shown in FIG. 2, a portion of the lead-in area 103 forms a control data zone 107. During the manufacture of the prior-art disc 100, information about the whole of the disc such as information representative of the size and type of the disc, and information representative of reference recording conditions such as a recommended recording laser power and a recommended recording laser waveform pattern are recorded on the control data zone 107.

The prior-art drive apparatus for the prior-art disc 100 implements trial write and read before recording user data (for example, contents data) on the prior-art disc 100. During a first stage of the trial write and read, test signals are sequentially recorded on the PCA 101 in the prior-art disc 100 while the recording power of a laser beam is changed among different values. The test signals are assigned to the different recording powers of the laser beam, respectively. During a second stage of the trial write and read, the recorded test signals are reproduced, and the reproduced test signals are evaluated. An optimum recording power of the laser beam is decided on the basis of the results of the evaluation of the reproduced test signals. During the recording of user data on the prior-art disc 100 which follows the trial write and read, the recording power of the laser beam is controlled at the decided optimum level. Deciding the optimum recording power of the laser beam on the basis of the reproduced test signals is called OPC (optimum power control). The PCA 101 is used for the OPC.

The RMA 102 in the prior-art disc 100 is assigned to recording management information (recording management data) which includes information for managing changes in the recording states of the lead-in area 103, the data area 104, and the lead-out area 105, and information for managing OPC-related information. The recording management information is recorded on the RMA 102 for every RMD (recording management data) block.

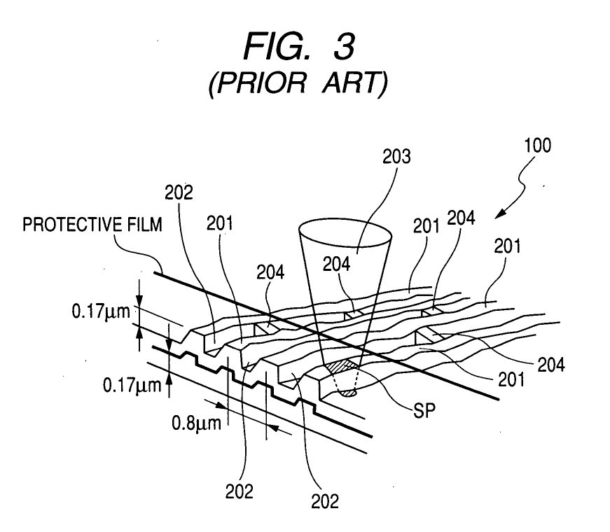

As shown in FIG. 3, the prior-art disc 100 has groove tracks 201 and land tracks 202 alternating with each other as viewed along a radial direction of the disc. The groove tracks 201 are main information recording tracks. Two land tracks 202 adjoining one groove track 201 are used for guiding a laser beam 203 to the groove track 201. Thus, the laser beam 203 is focused into a spot SP on the groove track 201.

On-disc address information is recorded on the prior-art disc 100 as land pre-pits (LPP) 204 in the land tracks 202 at the pre-formatting stage during the manufacture of the prior-art disc 100. The prior-art drive apparatus for the prior-art disc 100 reads out the on-disc address information from the LPP 204. During the recording of a signal on the prior-art disc 100, the prior-art drive apparatus controls a currently accessed position on the prior-art disc 100 in response to the read-out LPP address information. Not only the on-disc address information but also reference information representative of a recommended recording laser power and a recommended recording laser waveform pattern is recorded on the LPP 204 in advance.

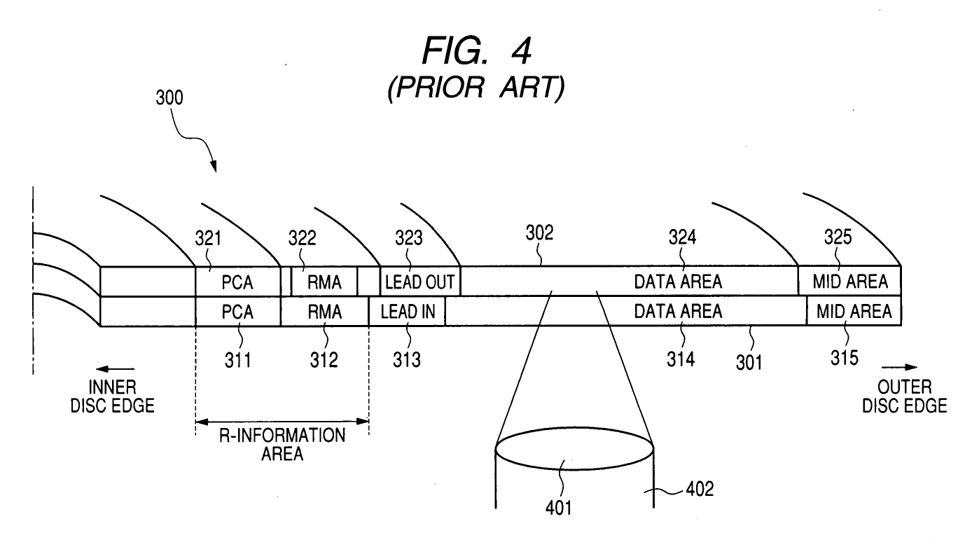

FIG. 4 shows a second prior-art DVD-RW 300. The prior-art disc 300 is of a two-layer single-sided type. The prior-art disc 300 has a laminated structure including a first recording layer 301 and a second recording layer 302 which are successively arranged in an axial direction of a laser beam 402 (or an axial direction of the disc). The first recording layer 301 is closer to an optical pickup (a recording and reproducing head) of a prior-art optical-disc drive apparatus than the second recording layer 302 is. An objective lens 401 in the optical pickup focuses the laser beam 402 onto either the first recording layer 301 or the second recording layer 302. The laser beam 402 reaches the second recording layer 302 after passing through the first recording layer 301.

The first recording layer 301 is divided into a PCA 311, an RMA 312, a lead-in area 313, a data area 314, and a middle area 315 which are successively arranged in that order as viewed along a radial direction from the inner disc edge toward the outer disc edge. The PCA 311 and the RMA 312 constitute an R-information area. The RMA 312 is assigned to recording management data (RMD) blocks. The second recording layer 302 is divided into a PCA 321, an RMA 322, a lead-out area 323, a data area 324, and a middle area 325 which are successively arranged in that order as viewed along a radial direction from the inner disc edge toward the outer disc edge. The PCA 321 and the RMA 322 constitute an R-information area. The RMA 322 is assigned to RMD blocks. The PCAs 311 and 321 are substantially equal in size, and align with each other. In other words, the PCAs 311 and 321 substantially entirely overlap each other.

The first recording layer 301 is similar to the recording layer in the prior-art disc 100 of FIG. 1 except that the middle area 315 replaces the lead-out area 105 (see FIG. 1). Thus, the lead-in area 313 in the first recording layer 301 has a control data zone which stores information about the whole of the disc such as information representative of the size and type of the disc, and information representative of reference recording conditions such as a recommended recording laser power and a recommended recording laser waveform pattern. The second recording layer 302 is similar to the first recording layer 301 except that the lead-out area 323 replaces the lead-in area 313. The first recording layer 301 is scanned by a spot of the laser beam 402 in a direction from the inner disc edge toward the outer disc edge during the recording of data thereon. The second recording layer 302 is scanned by the spot of the laser beam 402 in a direction from the outer disc edge toward the inner disc edge during the recording of data thereon.

The prior-art drive apparatus for the prior-art disc 300 performs OPC. Before the recording of user data on the data area 314 in the first recording layer 301, the prior-art drive apparatus implements OPC while using the PCA 311 in the first recording layer 301. Before the recording of user data on the data area 324 in the second recording layer 302, the prior-art drive apparatus implements OPC while using the PCA 321 in the second recording layer 302.

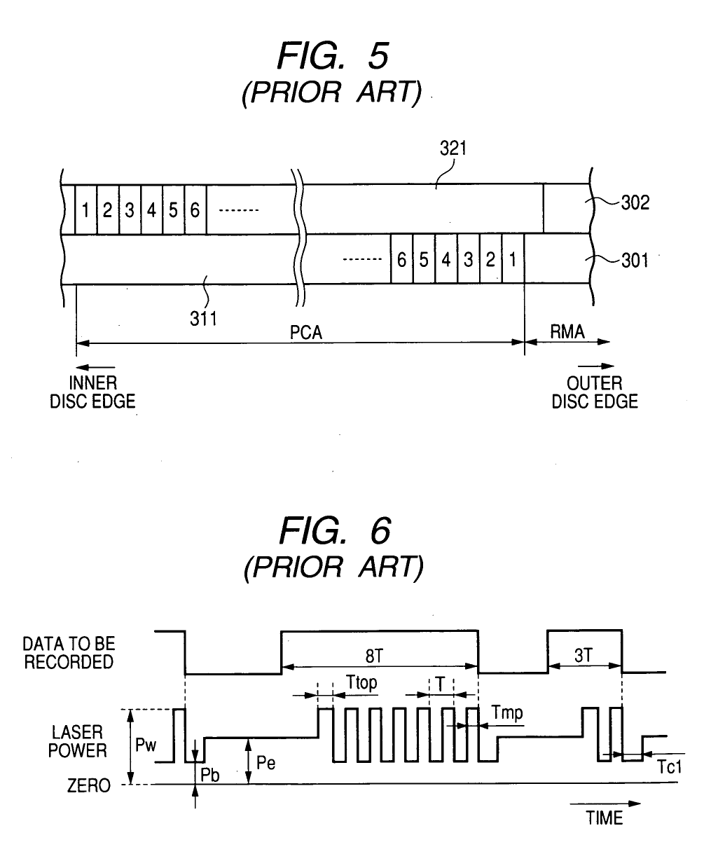

Specifically, the prior-art drive apparatus utilizes the PCAs 311 and 321 for the OPC in the following way. As shown in FIG. 5, the PCA 311 in the first recording layer 301 is divided into sections numbered “1”, “2”, “3”, . . . in a radial direction from the outer disc edge toward the inner disc edge. The prior-art drive apparatus sequentially uses the sections “1”, “2”, “3”, . . . of the PCA 311 for trial write and read. On the other hand, the PCA 321 in the second recording layer 302 is divided into sections numbered “1”, “2”, “3”, in a radial direction from the inner disc edge toward the outer disc edge. The prior-art drive apparatus sequentially uses the sections “1”, “2”, “3”, . . . of the PCA 321 for the trial write and read. An inner portion of the PCA 311 in the first recording layer 301 should remain unused so that the laser beam will reach the second recording layer 302 through the unused portion of the first recording layer 301 during the use of the PCA 321 in the second recording layer 302 for the trial write and read. As the trial write and read using the PCAs 311 and 321 are iterated, the inner edge of the used portion of the PCA 311 and the outer edge of the used portion of the PCA 321 are closer to each other. In the case where the distance between the inner edge of the used portion of the PCA 311 and the outer edge of the used portion of the PCA 321 decreases to or below a predetermined threshold value, further use of the PCA 321 for the OPC is inhibited. In this case, the used portion of the PCA 321 may be returned to an unused state by a signal erasing process so that the PCA 321 can be used for the OPC again.

To record data on a typical DVD-RW, a laser beam modulated in accordance with the data is applied to the DVD-RW. For example, the power of the laser beam changes among three different values, that is, a writing value Pw, an erasing value Pe, and a bottom value Pb in response to the data. The writing value Pw is greater than the erasing value Pe. The erasing value Pe is greater than the bottom value Pb. As shown in FIG. 6, the data to be recorded alternates between a high level and a low level while forming a train of positive pulses having durations including an 8T duration and a 3T duration, where T denotes the period of a channel clock signal. When the data changes to the low level, the power of the laser beam assumes the bottom value Pb. Thereafter, the power of the laser beam remains at the bottom value Pb for a given time interval Tc1, and then increases to the erasing value Pe. Subsequently, the power of the laser beam remains at the erasing value Pe even in the case where the data changes to the high level. During every positive pulse of the data, the power of the laser beam remains at the erasing value Pe for a certain time interval before alternating between the writing value Pw and the bottom value Pb. The alternation between the writing value Pw and the bottom value Pb forms a train of positive pulses in which the first pulse has a prescribed duration Ttop and the second and later pulses have a prescribed duration Tmp. In the train, the positive pulses occur at a period equal to T (the period of the channel clock signal). A recording layer in the DVD-RW can be changed between a crystalline state and an amorphous state depending on the power of the laser beam applied thereto. The writing power Pw of the laser beam causes a laser-illuminated portion of the recording layer to change from the crystalline state to the amorphous state to form a pit (a recorded mark) therein. The erasing power Pe of the laser beam causes a laser-illuminated portion of the recording layer to return from the amorphous state to the crystalline state to erase a pit therefrom. During most of the duration of every positive pulse of the data, the power of the laser beam alternates between the writing value Pw and the bottom value Pb to form a pit in the recording layer. In this case, the temporary laser power down to the bottom value Pb prevents the unwanted diffusion of heat in the recording layer.

In the prior-art disc 300 of FIG. 4, the laser beam 402 passes through the first recording layer 301 before being focused onto the second recording layer 302. Accordingly, it is desirable that the first recording layer 301 has a thin recording film. Since the prior-art disc 300 of the two-layer single-sided type has a complicated recording-layer structure, the management of recording conditions such as the power of the laser beam 402 regarding the prior-art disc 300 is more difficult than that regarding a single-layer disc.

The results of experiments performed by the inventors of this invention reveal that in the absence of the strict setting of recording conditions to optimum conditions during the recording of a signal on the first recording layer 301 in the prior-art disc 300, the signal reproduced from the first recording layer 301 tends to have a lot of errors. The results of the experiments also reveal that the recording/reproduction-related characteristics of the first recording layer 301 of the prior-art disc 300 vary as the number of times of signal recording thereon increases.

A sample signal was recorded on a given zone in the first recording layer 301 of a prior-art disc 300, and the recorded signal was reproduced therefrom. The error rate of the first reproduced signal was measured. Thereafter, the sample signal was repetitively recorded (rewritten) on and reproduced from the given zone in the first recording layer 301 of the prior-art disc 300. In this case, every signal recording was on an overwrite basis. The error rate of each of the second and later reproduced signals was measured. The repetitive recording of the sample signal was in same recording conditions.

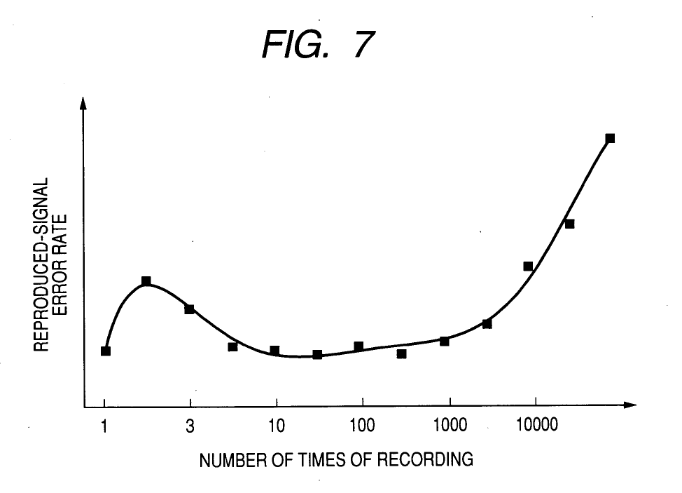

FIG. 7 shows the obtained relation between the reproduced-signal error rate and the number of times of signal recording (signal rewriting) on the prior-art disc 300. As shown in FIG. 7, the error rate of a reproduced signal originating from the second recorded signal was relatively bad. On the other hand, the error rate of a reproduced signal originating from each of the 10th to 1000th recorded signals was relatively good.

A sample signal was recorded on a given zone in the first recording layer 301 of a prior-art disc 300 by using a laser beam 402 having a power waveform similar to that in FIG. 6, and the recorded signal was reproduced therefrom. The error rate of the first reproduced signal was measured. Thereafter, the sample signal was recorded (rewritten) on the given zone in the first recording layer 301 by using the laser beam 402 having a power waveform similar to that in FIG. 6, and the recorded signal was reproduced therefrom. The error rate of the second reproduced signal was measured. The sequence of the above steps was iterated while the writing power Pw of the laser beam 402 was changed among different values.

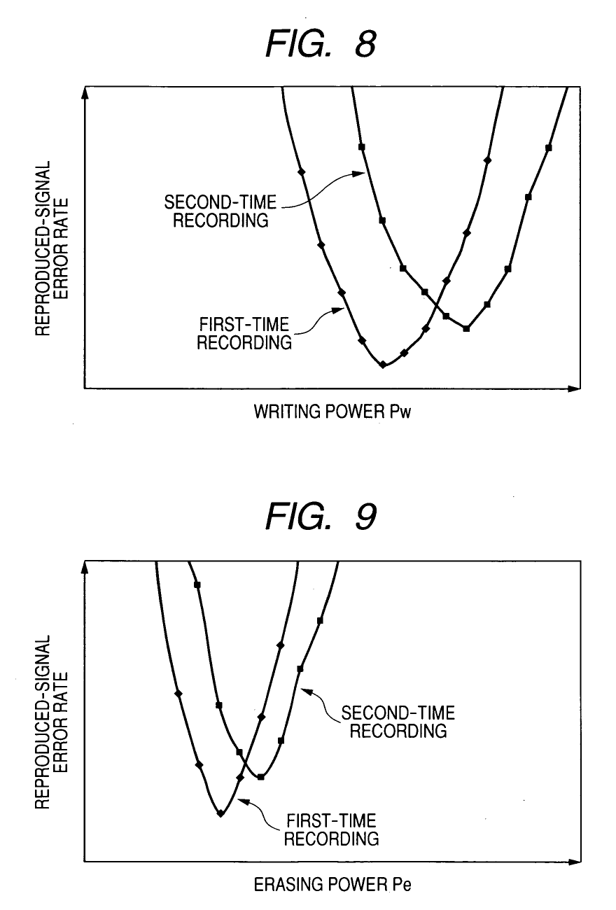

FIG. 8 shows the obtained relation among the reproduced-signal error rate, the number of times of signal recording (signal rewriting) on the prior-art disc 300, and the writing power Pw of the laser beam 402. As shown in FIG. 8, the reproduced-signal error rate greatly depended on the writing power Pw of the laser beam 402. There was an appreciable difference in optimum writing power of the laser beam 402 between the first signal recording on the prior-art disc 300 and the second signal recording thereon.

A sample signal was recorded on a given zone in the first recording layer 301 of a prior-art disc 300 by using a laser beam 402 having a power waveform similar to that in FIG. 6, and the recorded signal was reproduced therefrom. The error rate of the first reproduced signal was measured. Thereafter, the sample signal was recorded (rewritten) on the given zone in the first recording layer 301 by using the laser beam 402 having a power waveform similar to that in FIG. 6, and the recorded signal was reproduced therefrom. The error rate of the second reproduced signal was measured. The sequence of the above steps was iterated while the erasing power Pe of the laser beam 402 was changed among different values.

FIG. 9 shows the obtained relation among the reproduced-signal error rate, the number of times of signal recording (signal rewriting) on the prior-art disc 300, and the erasing power Pe of the laser beam 402. As shown in FIG. 9, the reproduced-signal error rate greatly depended on the erasing power Pe of the laser beam 402. There was an appreciable difference in optimum erasing power of the laser beam 402 between the first signal recording on the prior-art disc 300 and the second signal recording thereon.

### First Embodiment

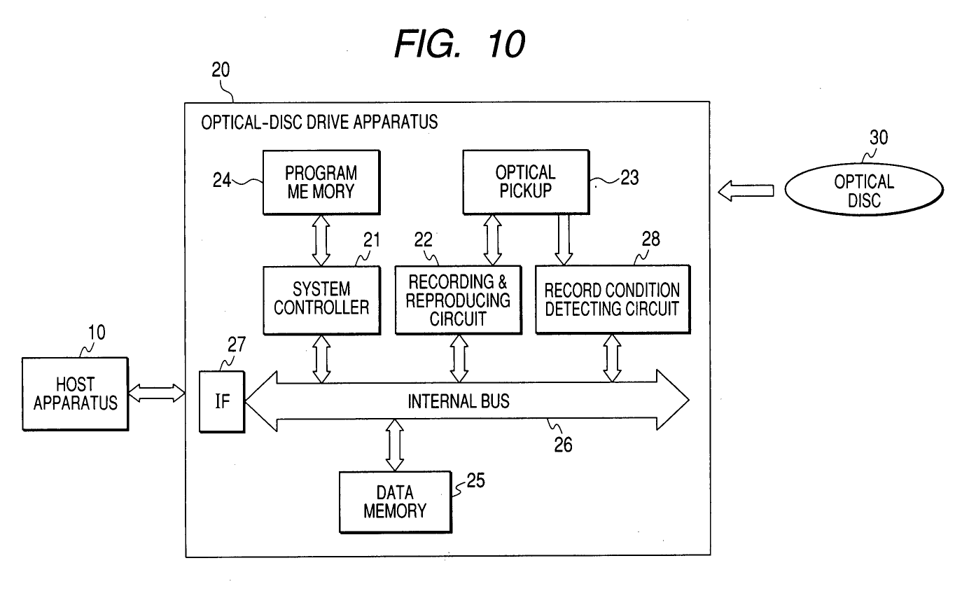

FIG. 10 shows an information recording and reproducing system including a host apparatus 10, an optical-disc drive apparatus 20, and an optical disc 30. The optical-disc drive apparatus 20 and the optical disc 30 are in a first embodiment of this invention. The host apparatus 10 and the optical-disc drive apparatus 20 are connected with each other. The optical disc 30 can be inserted into and ejected from the body of the optical-disc drive apparatus 20.

The optical disc 30 is of a two-layer single-sided structure similar to that in FIG. 4. The optical disc 30 uses a rewritable disc such as a digital versatile disc rewritable (DVD-RW). Specifically, the optical disc 30 includes a laminate of first and second recording layers each having a PCA (a trial write area), an RMA, a data area, and other areas. The first recording layer means one of the two recording layers which is closer to an optical pickup of the optical-disc drive apparatus 20 than the other recording layer is. The optical disc 30 is formed with a central opening, and thus has an inner circumferential edge in addition to an outer circumferential edge.

The optical disc 30 has land pre-pits (LPP) representing address information. The first recording layer in the optical disc 30 has a lead-in area including a control data zone. The land pre-pits or the control data zone prestores reference information including recording-condition-related information and disc type information.

The host apparatus 10 includes, for example, a personal computer. The host apparatus 10 can issue various instructions to the optical-disc drive apparatus 20. The host apparatus 10 can instruct the optical-disc drive apparatus 20 to record information on the optical disc 30 or reproduce information therefrom. It should be noted that the host apparatus 10 and the optical-disc drive apparatus 20 may be located in a common casing. For example, the host apparatus 10 and the optical-disc drive apparatus 20 are combined to form an optical-disc recorder or an optical-disc recordable player.

The optical-disc drive apparatus 20 has not only the function of recording information on the optical disc 30 but also the function of reproducing information therefrom. The optical-disc drive apparatus 20 reproduces the LPP address information from the optical disc 30. During the recording of information on the optical disc 30 or the reproduction of information therefrom, the optical-disc drive apparatus 20 controls the currently-accessed position on the optical disc 30 according to the reproduced LPP address information.

The optical-disc drive apparatus 20 includes a system controller 21, a recording and reproducing circuit 22, an optical pickup (a recording and reproducing head) 23, a program memory 24, a data memory 25, an internal bus 26, an interface 27, and a record-condition detecting circuit 28.

The system controller 21, the recording and reproducing circuit 22, the data memory 25, the interface 27, and the record-condition detecting circuit 28 are bidirectionally connected by the internal bus 26. The program memory 24 is connected with the system controller 21. The optical pickup 23 is connected with the recording and reproducing circuit 22, and the record-condition detecting circuit 28. The optical pickup 23 can optically access the optical disc 30 which is placed at its normal position within the body of the optical-disc drive apparatus 20. During the access to the optical disc 30, the optical pickup 23 applies a laser beam thereto and receives a reflected laser beam therefrom. The optical disc 30 is scanned by the laser beam applied from the optical pickup 23. The interface 27 is connected with the host apparatus 10.

The system controller 21 includes a signal processor or a CPU. The system controller 21 acts to control the whole of the optical-disc drive apparatus 20 and the devices and circuits therein according to a control program (a computer program). The recording and reproducing circuit 22 implements writing and reading information in and from the optical disc 30 via the optical pickup 23. The program memory 24 stores the control program for the system controller 21. Data to be recorded on the optical disc 30, data reproduced from the optical disc 30, and management information can be written into and read out from the data memory 25, and temporarily stored therein. The optical pickup 23 optically writes and reads data into and from the optical disc 30 while applying the laser beam thereto. The interface 27 connects the host apparatus 10 and the internal bus 26.

The recording and reproducing circuit 22 and the optical pickup 23 cooperate to write and read contents information (user data) and management information in and from the optical disc 30. In addition, the recording and reproducing circuit 22 and the optical pickup 23 cooperate to implement trial write and read with respect to the optical disc 30. The trial write and read is also referred to as the OPC (optimum power control) procedure.

During the OPC procedure, the optical pickup 23 records test signals on the optical disc 30 while changing a recording condition among different values. The recorded test signals are assigned to the different recording-condition values, respectively. The optical pickup 23 reproduces the test signals therefrom. The record-condition detecting circuit 28 receives the reproduced test signals from the optical pickup 23. The record-condition detecting circuit 28 measures specified feature values of the reproduced test signals. The measured feature values relate to the conditions of the recorded test signals corresponding to the reproduced test signals. The record-condition detecting circuit 28 sends data representative of the measured values (the measured feature values) to the system controller 21 of via the internal bus 26.

The system controller 21, the recording and reproducing circuit 22, the optical pickup 23, the program memory 24, the data memory 25, the internal bus 26, the interface 27, and the record-condition detecting circuit 28 in the optical-disc drive apparatus 20 constitute a computer system which operates according to the control program stored in the program memory 24. Therefore, the optical-disc drive apparatus 20 operates in accordance with the control program. The control program is designed to enable the optical-disc drive apparatus 20 and the devices 21-28 therein to implement the previously-mentioned operation steps and also operation steps indicated hereafter.

The system controller 21 receives, from the record-condition detecting circuit 28, the data representative of the measured values (the measured feature values) of the reproduced test signals. The system controller 21 calculates characteristic parameters of the reproduced test signals from the measured values. The characteristic parameters indicate the qualities of the reproduced test signals as well as the conditions of the recorded test signals. Thus, the calculated characteristic parameters can be utilized for evaluating the reproduced test signals and the conditions of the recorded test signals. The system controller 21 decides optimum values of the writing and erasing powers Pw and Pe of the laser beam on the basis of the calculated characteristic parameters.

The optical disc 30 is of a phase change type. Each of the recording layers in the optical disc 30 changes between a crystalline state and an amorphous state according to information recorded thereon. The state change (phase change) is reversible.

During the recording of information on the optical disc 30, the laser beam applied to the optical disc 30 from the optical pickup 23 has a multi-pulse-train waveform similar to that in FIG. 6. The laser beam is modulated by the optical-disc drive apparatus 20 (the optical pickup 23) in accordance with NRZI data to be recorded. A drive pulse train occurs in the waveform of the laser beam in accordance with the logic state of the NRZI data.

While the NRZI data is in its low level state, the laser beam is controlled by the optical-disc drive apparatus 20 (the optical pickup 23) to take a bottom power level Pb for a given time interval Tc1 and then continuously take an erasing power level Pe (see FIG. 6). While the NRZI data is in its high level state, the laser beam is controlled by the optical-disc drive apparatus 20 (the optical pickup 23) to continuously take the erasing power level Pe for a prescribed time interval and then alternate between a writing power level Pw and the bias power level Pb to form a drive pulse train (see FIG. 6). In the drive pulse train, positive pulses occur at a period equal to T (the period of a channel clock signal), and the first positive pulse has a prescribed duration Ttop and the second and later positive pulses have a prescribed duration Tmp. The writing power level Pw is higher than the erasing power level Pe. The bias power level Pb is lower than the erasing power level Pe.

Accordingly, during most of the time interval for which the NRZI data is in its high level state, the power of the laser beam alternates between the writing level Pw and the bias level Pb so that a portion of a recording layer in the optical disc 30 which is exposed to the laser beam is abruptly heated and cooled and thus falls into an amorphous state to form a recorded mark (a pit). During most of the time interval for which the NRZI data is in its low level state, the laser beam continuously takes the erasing power level Pe so that a portion of a recording layer in the optical disc 30 which is exposed to the laser beam is annealed at a low temperature and thus falls into a crystalline state. Generally, as the portion of the recording layer falls into the crystalline state, a recorded mark (a pit) is erased therefrom.

It should be noted that the NRZI data may be replaced by other modulation data.

The optical-disc drive apparatus 20 employs a similar waveform of the laser beam to record user data over a used portion of the data area of a recording layer (the first recording layer or the second recording layer) in the optical disc 30 on a direct overwrite basis regardless of whether the used portion of the data area is in the crystalline state or the amorphous state before the recording.

The trial write and read implemented by the optical-disc drive apparatus 20 with respect to the optical disc 30 is designed to include the following procedure. The optical-disc drive apparatus 20 designates one among sections of the PCA of a recording layer (the first recording layer or the second recording layer) in the optical disc 30 as a section to be used for the trial write and read. The optical-disc drive apparatus 20 subjects the designated section in the PCA to ordinary DC (direct current) erasure. Specifically, during the ordinary DC erasure, the optical-disc drive apparatus 20 scans the designated section in the PCA by the laser beam having a prescribed constant power chosen so that the whole of the designated section will be in the crystalline state and all the recorded data will be erased therefrom. Preferably, the prescribed constant power (the ordinary DC erasing power) of the laser beam is substantially equal to, for example, the previously-indicated erasing power Pe. After the ordinary DC erasure has been completed, the optical-disc drive apparatus 20 performs the main part of the trial write and read through the use of the designated section in the PCA to decide optimum values of the writing and erasing powers Pw and Pe of the laser beam. Specifically, the optical-disc drive apparatus 20 sequentially records test signals on the designated section in the PCA while changing the writing power Pw or the erasing power Pe of the laser beam among different values. The recorded test signals are assigned to the different laser power values, respectively. The optical-disc drive apparatus 20 reproduces the recorded test signals from the designated section in the PCA.

In the case where the optical-disc drive apparatus 20 is requested to reproduce recorded information or recorded signals (for example, recorded test signals) from the optical disc 30, the optical pickup 23 applies a reproducing laser beam to a designated area in a recording layer (the first recording layer or the second recording layer) of the optical disc 30 and receives a reflected laser beam therefrom. The optical pickup 23 changes the received laser beam into reproduced RF signals representative of the recorded information or the recorded signals through photoelectric conversion. The optical pickup 23 sequentially outputs the reproduced RF signals to the recording and reproducing circuit 22 and the record-condition detecting circuit 28.

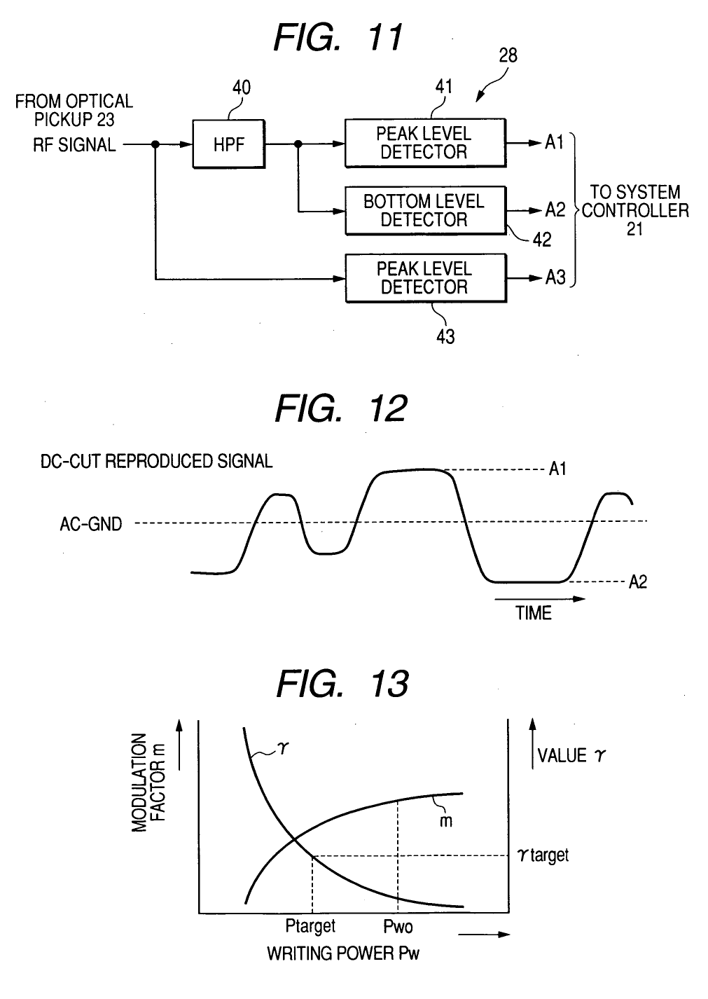

As shown in FIG. 11, the record-condition detecting circuit 28 includes a high pass filter (HPF) 40, a peak level detector 41, a bottom level detector 42, and a peak level detector 43.

The high pass filter 40 and the peak level detector 43 receive each reproduced RF signal from the optical pickup 23. The peak level detector 43 detects a plus-side peak A3 of the reproduced RF signal, and outputs data representative of the detected plus-side peak A3 to the system controller 21.

The high pass filter 40 cuts off a direct-current component from the reproduced RF signal to get a DC-cut reproduced signal having a waveform such as shown in FIG. 12. The high pass filter 40 outputs the DC-cut reproduced signal to the peak level detector 41 and the bottom level detector 42.

The peak level detector 41 detects a plus-side peak A1 of the reproduced RF signal (see FIG. 12), and outputs data representative of the detected plus-side peak A1 to the system controller 21.

The bottom level detector 42 detects a bottom level A2, that is, a minus-side peak A2 of the reproduced RF signal (see FIG. 12), and outputs data representative of the detected minus-side peak A2 to the system controller 21.

The system controller 21 receives the data representative of the detected peaks A1, A2, and A3 from the devices 41, 42, and 43 in the record-condition detecting circuit 28. The system controller 21 calculates a characteristic parameter of each reproduced RF signal from the detected peaks A1, A2, and A3. The characteristic parameter is selected from an asymmetry value “β”, a modulation factor “m”, and a modulation-factor derivative value “γ”.

The system controller 21 calculates the asymmetry value “β” of each reproduced RF signal from the detected peaks A1 and A2 according to the following equation:
β=(A1+A2)/(A1−A2) (1)

The system controller 21 calculates the modulation factor “m” of each reproduced RF signal from the detected peaks A1, A2, and A3 according to the following equation:
m=(A1−A2)/A3 (2)

In general, the modulation factor “m” of a reproduced signal depends on the writing power Pw of a laser beam used to record a signal from which the reproduced signal originates. As shown in FIG. 13, the modulation factor “m” increases as the writing power Pw of the laser beam rises. The modulation factor “m” saturates when the writing power Pw enters a certain range. The error rate of a reproduced signal is minimized in the case where the writing power Pw of a laser beam used to record an original signal is equal to a value at which the modulation factor “m” starts saturating. Thus, it is preferable to set an optimum writing power Pwo to the writing power Pw equal to a value at which the modulation factor “m” starts saturating.

The system controller 21 has or receives information about the writing power Pw of the laser beam used to record a signal from which each reproduced RF signal originates. The system controller 21 calculates the modulation-factor derivative value “γ” of each reproduced RF signal from the calculated modulation factor “m” and the writing power Pw of the laser beam according to the following equation:
γ=(dm/dPw)·(Pw/m) (3)
where dm/dPw denotes differentiating the modulation factor “m” with respect to the writing power Pw of the laser beam.

In general, the modulation-factor derivative value “γ” of a reproduced signal depends on the writing power Pw of a laser beam used to record a signal from which the reproduced signal originates. As shown in FIG. 13, the modulation-factor derivative value “γ” decreases as the writing power Pw of the laser beam rises. There is a prescribed target “γtarget” for the modulation-factor derivative value “γ”. A target Ptarget for the writing laser power Pw corresponds to the target “γtarget”.

In general, the asymmetry value “β” of a reproduced signal depends on the writing power Pw of a laser beam used to record a signal from which the reproduced signal originates. Furthermore, the modulation factor “m”, the modulation-factor derivative value “γ”, and the asymmetry value “β” of a reproduced signal depend on the erasing power Pe of a laser beam used to record a signal from which the reproduced signal originates. Basically, the relation of the erasing power Pe of the laser beam with the modulation factor “m”, the modulation-factor derivative value “γ”, and the asymmetry value “β” of the reproduced signal is similar to that of the writing power Pw of the laser beam therewith.

The optical disc 30 may have only a single recording layer. Optical discs 30 each having a single recording layer are of plural types. In the case of a single-layer optical discs 30, the relations of the writing and erasing powers Pw and Pe of a laser beam with the asymmetry value “β”, the modulation-factor derivative value “γ”, and the modulation factor “m” of a reproduced signal are substantially fixed for discs of each type. Thus, for each single-layer disc type, it is preferable to perform the following steps in advance. Sample signals are recorded on a sample disc by using a laser beam having writing and erasing powers Pw and Pe which change among different values. The recorded sample signals are reproduced from the sample disc to generate reproduced signals. The error rates of the reproduced signals are measured. The lowest one is detected among the measured error rates of the reproduced signals. A decision is made as to the values of the writing and erasing powers Pw and Pe of the laser beam used to record a sample signal corresponding to the lowest-error-rate reproduced signal. The modulation-factor derivative value “γ” of the lowest-error-rate reproduced signal is measured through the use of the decided values of the writing and erasing power Pw and Pe of the laser beam. The asymmetry value “β” of the lowest-error-rate reproduced signal is measured. The measured modulation-factor derivative value “γ” and the measured asymmetry value “β” are labeled as target ones “γtarget” and “βtarget”, respectively. Reference data (reference information) representing the target modulation-factor derivative value “γtarget” and the target asymmetry value “βtarget” is pre-recorded on an optical disc 30 during the manufacture thereof.

When being loaded with a single-layer optical disc 30, the optical-disc drive apparatus 20 reads out reference data representative of a target asymmetry value “βtarget” and a target modulation-factor derivative value “γtarget” from the disc. In the optical-disc drive apparatus 20, the read-out reference data is transferred from the optical pickup 23 to the data memory 25 through the recording and reproducing circuit 22 and the internal bus 26 under the control by the system controller 21. Thus, the data memory 25 stores the reference data representative of the target asymmetry value “βtarget” and the target modulation-factor derivative value “γtarget”. The optical-disc drive apparatus 20 performs an OPC procedure with respect to the single-layer optical disc 30 as follows. The optical-disc drive apparatus 20 sequentially record test signals on the single-layer optical disc 30 while changing the writing power Pw of the laser beam among ten different values and changing the erasing power Pe of the laser beam among ten different values. The recorded test signals are assigned to one-hundred different pairs of a writing power value and an erasing power value, respectively. The optical-disc drive apparatus 20 reproduces the recorded test signals from the single-layer optical disc 30 to obtain reproduced signals. The optical-disc drive apparatus 20 calculates the asymmetry values “β” of the respective reproduced signals through the operation of the record-condition detecting circuit 28 and the system controller 21. One-hundred different pairs of a writing power value and an erasing power value correspond to the calculated asymmetry values “β”, respectively. The optical-disc drive apparatus 20 searches the calculated asymmetry values “β” for one equal or closest to the target asymmetry value “βtarget” represented by the reference data in the data memory 25. Then, the optical-disc drive apparatus 20 finds the pair of the writing power value and the erasing power value corresponding to the search-result calculated asymmetry value “β” equal or closest to the target asymmetry value “βtarget”. The optical-disc drive apparatus 20 labels the writing power value and the erasing power value in the found pair as optimum values of the writing and erasing powers Pw and Pe of the laser beam respectively. Thus, the OPC procedure with respect to the single-layer optical disc 30 is completed. It should be noted that the OPC procedure may employ modulation-factor derivative values “γ” instead of asymmetry values “β”.

The inventors of this invention performed the following experiments on a rewritable optical disc of a two-layer single-sided structure. A sample signal was recorded on a prescribed area in the first recording layer of the optical disc through the use of a laser beam having preset writing and erasing powers. The recorded signal was reproduced from the optical disc. The asymmetry value “β” of the first reproduced signal was measured. Thereafter, the sample signal was repetitively recorded (rewritten) on the prescribed area in the first recording layer of the optical disc through the use of the laser beam having the preset writing and erasing powers, and was repetitively reproduced therefrom. In this case, every signal recording was on an overwrite basis. The asymmetry value “β” of each of the second and later reproduced signals was measured.

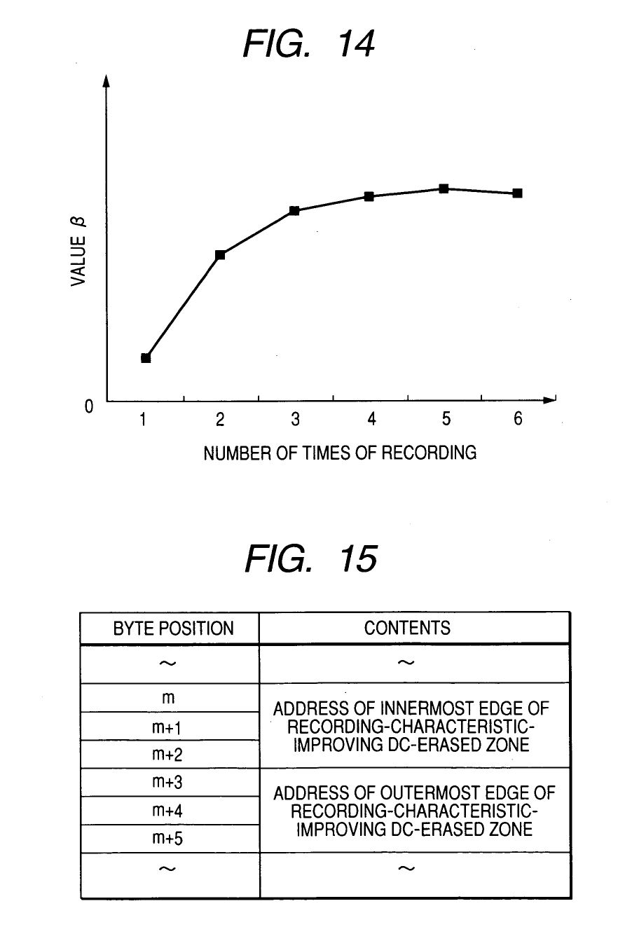

FIG. 14 shows the obtained relation between the reproduced-signal asymmetry value “β” and the number of times of signal recording (signal rewriting) on the optical disc. As shown in FIG. 14, the reproduced-signal asymmetry value “⊖” varied in accordance with the number of times of signal recording on the optical disc. The asymmetry value “β” of a reproduced signal originating from the first recorded signal was relatively small. The reproduced-signal asymmetry value “β” rose as the number of times of signal recording on the optical disc increased from one to three. The reproduced-signal asymmetry value “β” remained substantially equal to a certain value as the number of times of signal recording on the optical disc increased from four.

Accordingly, to enable an OPC procedure using a reproduced-signal asymmetry value “β” to decide reliable and accurate optimum values of the recording and erasing powers Pw and Pe of a laser beam, it is desirable to compensate for the above-indicated dependence of the reproduced-signal asymmetry value “β” upon the number of times of signal recording on a rewritable optical disc of a two-layer single-sided structure.

When being loaded with an optical disc 30, the optical-disc drive apparatus 20 operates as follows. First, the optical pickup 23 in the optical-disc drive apparatus 20 reads out disc type information from the control data zone in the lead-in area of the optical disc 30 while being controlled by the system controller 21. The system controller 21 decides the type of the optical disc 30 by referring to the read-out disc type information. In the case where the type of the optical disc 30 is decided to be of the two-layer single-sided type, the optical-disc drive apparatus 20 further operates as follows.

The optical pickup 23 in the optical-disc drive apparatus 20 reads out the newest RMD block from the RMA in the first recording layer of the optical disc 30 while being controlled by the system controller 21. The read-out RMD block is sent from the optical pickup 23 to the system controller 21 via the recording and reproducing circuit 22. The system controller 21 obtains, from the read-out newest RMD block, information of a recording-characteristic-improving DC-erased zone, specifically, information representing the addresses of the innermost and outermost edges of the recording-characteristic-improving DC-erased zone.

FIG. 15 shows the contents of a portion of one RMD block in which a field extending from a byte position of “m” to a byte position of “m+5” stores information of a recording-characteristic-improving DC-erased zone provided in the PCA of the first recording layer in the optical disc 30. Specifically, the first field half extending from a byte position of “m” to a byte position of “m+2” stores an information piece representing the address of the innermost edge of the recording-characteristic-improving DC-erased zone. The second field half extending from a type position of “m+3” to a byte position of “m+5” stores an information piece representing the address of the outermost edge of the recording-characteristic-improving DC-erased zone.

The system controller 21 compares the addresses of the innermost and outermost edges of the recording-characteristic-improving DC-erased zone with those of the inner and outer circumferences of the PCA in the first recording layer of the optical disc 30. The system controller 21 decides whether or not the recording-characteristic-improving DC-erased zone extends over the whole of the PCA on the basis of the results of the comparison. It should be noted that the place of the PCA relative to the optical disc 30 is predetermined, and information representing the predetermined PCA place in terms of LPP addresses is previously stored in a memory (the program memory 24, the data memory 25, or another memory) within the optical-disc drive apparatus 20, and that the address of the outer circumference of the PCA and the address of the inner circumference of the PCA are derived from the PCA place information.

When the address of the innermost edge of the recording-characteristic-improving DC-erased zone is greater in value than the address of the inner circumference of the PCA, or when the address of the outermost edge of the recording-characteristic-improving DC-erased zone is smaller in value than the address of the outer circumference of the PCA, the system controller 21 decides that the recording-characteristic-improving DC-erased zone is narrower than the PCA and does not extend over the whole of the PCA. On the other hand, when the addresses of the innermost and outermost edges of the recording-characteristic-improving DC-erased zone are equal to those of the inner and outer circumferences of the PCA respectively, the system controller 21 decides that the recording-characteristic-improving DC-erased zone extends over the whole of the PCA.

In the case where the optical disc 30 is virgin, no RMD block is recorded thereon or an RMD block recorded thereon has bits of “0” occupying the field extending from a byte position of “m” to a byte position of “m+5”. When detecting that no RMD block is recorded on the optical disc 30 or the read-out RMD block has bits of “0” occupying the field extending from a byte position of “m” to a byte position of “m+5”, the system controller 21 decides that the optical disc 30 is virgin.

When it is decided that the recording-characteristic-improving DC-erased zone does not extend over the whole of the PCA, or when it is decided that the optical disc 30 is virgin, the optical pickup 23 reads out reference information from the land pre-pits (LPP) or the control data zone in the lead-in area of the optical disc 30 under the control by the system controller 21. The reference information represents a reference writing power (a recommended writing power) Pwc of a laser beam, a ratio “εc” between a reference erasing power (a recommended erasing power) Pec of the laser beam and the reference writing power Pwc thereof, and a coefficient “μ” for a recording-characteristic-improving DC erasing power of the laser beam. The read-out reference information is sent from the optical pickup 23 to the system controller 21 via the recording and reproducing circuit 22.

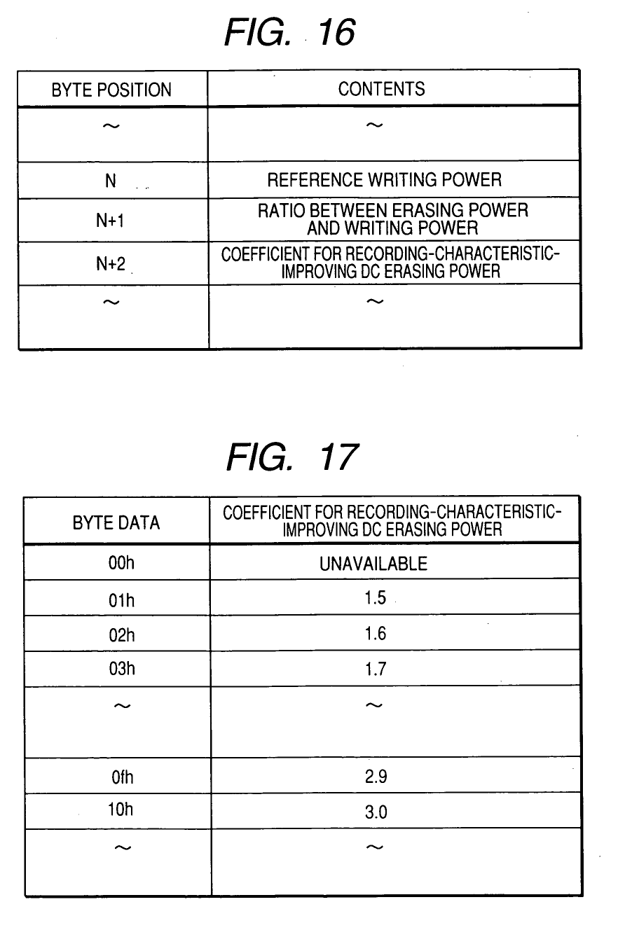

FIG. 16 shows the format of a portion of reference information recorded on the land pre-pits (LPP) or the control data zone in the lead-in area of an optical disc 30. As shown in FIG. 16, a byte position of “N” is occupied by a first piece of the reference information which represents a reference writing power Pwc of a laser beam. A byte position of “N+1” is occupied by a second piece of the reference information which represents a ratio “εc” between a reference erasing power Pec of the laser beam and the reference writing power Pwc thereof. A byte position of “N+2” is occupied by a third piece of the reference information which represents a coefficient “μ” for a recording-characteristic-improving DC erasing power of the laser beam.

As shown in FIG. 17, different states of a byte in a position of “N+2” are assigned to different values of the coefficient “μ” for the recording-characteristic-improving DC erasing power of the laser beam respectively. Specifically, a byte of “01h” is assigned to a coefficient value of 1.5. Then, each time the byte increases by “1h”, the coefficient value increments by 0.1. A byte of “10h” is assigned to a coefficient value of 3.0. A byte of “00h” indicates that stored reference-information piece representing a coefficient “μ” is absent from the optical disc 30.

The optical-disc drive apparatus 20 can subject the optical disc 30 to not only the recording-characteristic-improving DC erasure but also the ordinary DC erasure which employs a laser beam having an ordinary DC erasing power Pedc. The optical-disc drive apparatus 20 sets the ordinary DC erasing power Pedc equal to or slightly greater than the product of the reference writing power Pwc and the ratio “εc”.

After the read-out of the reference information from the optical disc 30, the optical pickup 23 in the optical-disc drive apparatus 20 focuses the laser beam on the first recording layer of the optical disc 30 while being controlled by the system controller 21. Then, the optical-disc drive apparatus 20 subjects a portion of the PCA in the first recording layer of the optical disc 30 which extends outside the recording-characteristic-improving DC-erased zone to the recording-characteristic-improving DC erasure. During the recording-characteristic-improving DC erasure, the optical pickup 23 drives the laser beam to scan the above-indicated portion of the PCA and maintains the power of the laser beam at a value (μ·Pedc) equal to the product of the coefficient “μ” and the ordinary DC erasing power Pedc while being controlled by the system controller 21.

The inventors of this invention performed the following experiments on a rewritable optical disc of a two-layer single-sided structure. A prescribed area in the first recording layer of the optical disc was subjected to the recording-characteristic-improving DC erasure using a laser beam having a power equal to a value calculated from a coefficient “μ” of 2.0. Thereafter, a sample signal was recorded on the prescribed area in the first recording layer of the optical disc through the use of the laser beam having preset writing and erasing powers. The recorded signal was reproduced from the optical disc. The asymmetry value “β” of the first reproduced signal was measured. Thereafter, the sample signal was repetitively recorded (rewritten) on the prescribed area in the first recording layer of the optical disc through the use of the laser beam having the preset writing and erasing powers, and was repetitively reproduced therefrom. In this case, every signal recording was on an overwrite basis. The asymmetry value “β” of each of the second and later reproduced signals was measured.

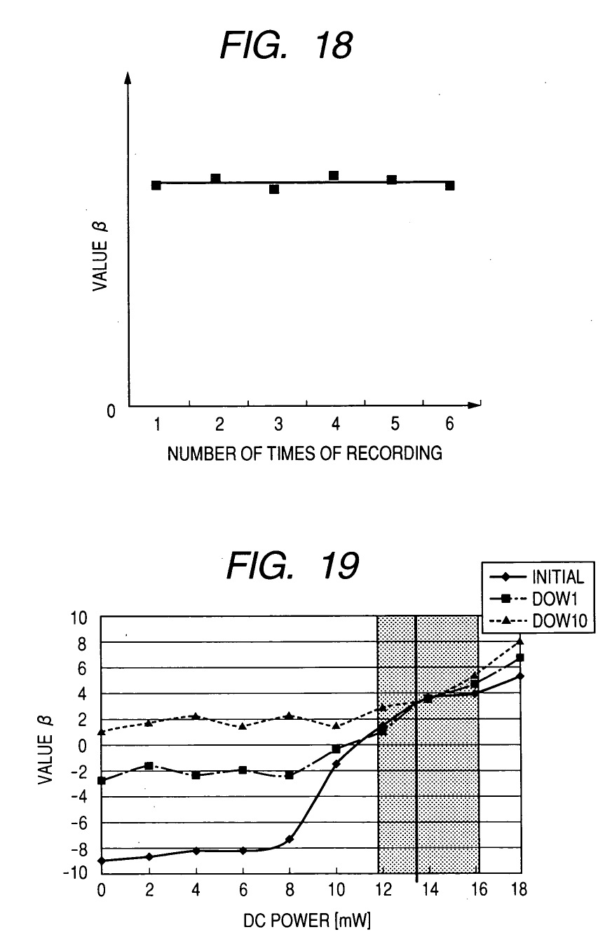

FIG. 18 shows the obtained relation between the reproduced-signal asymmetry value “β” and the number of times of signal recording (signal rewriting) on the optical disc. As shown in FIG. 18, the reproduced-signal asymmetry value “β” remained substantially constant independent of the number of times of signal recording on the optical disc.

The inventors of this invention performed the following experiments on a rewritable optical disc of a two-layer single-sided structure. A prescribed area in the first recording layer of the optical disc was subjected to the recording-characteristic-improving DC erasure using a laser beam having a DC erasing power. Thereafter, a sample signal was recorded on the prescribed area in the first recording layer of the optical disc through the use of the laser beam having preset writing and erasing powers. The recorded signal was reproduced from the optical disc. The asymmetry value “β” of the first reproduced signal was measured. Thereafter, the sample signal was repetitively recorded (rewritten) on the prescribed area in the first recording layer of the optical disc through the use of the laser beam having the preset writing and erasing powers, and was repetitively reproduced therefrom. In this case, every signal recording was on an overwrite basis. The asymmetry value “β” of each of the second and later reproduced signals was measured. The recording and reproduction of the sample signal, and the measurement of the asymmetry value “β” were repeated eleven times. The sequence of the above steps was iterated while the DC erasing power of the laser beam in the recording-characteristic-improving DC erasure was changed among different values.

FIG. 19 shows the obtained relation among the measured asymmetry value “β”, the number of times of signal recording (signal rewriting) on the optical disc, and the DC erasing power of the laser beam used in the recording-characteristic-improving DC erasure. In FIG. 19, the marks “♦” (the marks INITIAL) denote the relation between the DC erasing power of the laser beam and the measured asymmetry value “β” regarding the first reproduced signal. The marks “▪” (the marks DOW1) denote the relation between the DC erasing power of the laser beam and the measured asymmetry value “β” regarding the second reproduced signal. The marks “▴” (the marks DOW10) denote the relation between the DC erasing power of the laser beam and the measured asymmetry value “β” regarding the eleventh reproduced signal. During every recording of the test signal, the preset erasing power of the laser beam was equal to 6.8 mW. As shown in FIG. 19, in the case where the DC erasing power of the laser beam in the recording-characteristic-improving DC erasure was in the range of 12 mW to 16 mW, the relation between the measured asymmetry value “β” and the DC erasing power was substantially independent of the number of times of signal recording on the optical disc. It should be noted that 12 mW is equal to 6.8 mW multiplied by about 1.8, and 16 mW is equal to 6.8 mW multiplied by about 2.4. A variation in the measured asymmetry value “β” was minimized when the recording-characteristic-improving DC erasure was equal to 14 mW. It should be noted that 14 mW is equal to 6.8 mW multiplied by about 2.0. Thus, a coefficient “μ” of 2.0 corresponds to a minimized variation in the measured asymmetry value “β”. It was found that the measured asymmetry value “β” was made substantially independent of the number of times of signal recording on the optical disc by the recording-characteristic-improving DC erasure using a laser beam having a power equal to a value calculated from a coefficient “μ” in the range of 1.5 to 3.0. Accordingly, a preferable range of the coefficient “μ” extends from 1.5 to 3.0.

It was found that the repetitive exposure of a prescribed area in an optical disc to the recording-characteristic-improving DC erasure using a laser beam having a power equal to a value μ·Pedc reduced the number of times signal rewriting could be reliably performed on the prescribed area in the optical disc. Accordingly, it is preferable that every prescribed area in the optical disc 30 is subjected to the recording-characteristic-improving DC erasure only once.

After the recording-characteristic-improving DC erasure is started, the optical-disc drive apparatus 20 periodically checks whether an instruction for user-data recording, user-data playback, or disc ejection comes from the host apparatus 10. The optical-disc drive apparatus 20 continues the recording-characteristic-improving DC erasure until such an instruction comes. As the recording-characteristic-improving DC erasure is continued, the PCA in the first recording layer of the optical disc 30 remains scanned by the laser beam so that the recording-characteristic-improving DC-erased zone in the PCA expands.

In the case where the whole of the PCA in the first recording layer of the optical disc 30 has been subjected to the recording-characteristic-improving DC erasure, the system controller 21 in the optical-disc drive apparatus 20 generates an updated RMD block (a new RMD block). The system controller 21 loads byte positions of “m” to “m+2” in the updated RMD block with an information piece representing an address equal to the address of the inner circumference of the PCA. Furthermore, the system controller loads byte positions of “m+3” to “m+5” in the updated RMD block with an information piece representing an address equal to the address of the outer circumference of the PCA. Then, the system controller 21 controls the recording and reproducing circuit 22 and the optical pickup 23 to record the updated RMD block in the RMA of the first recording layer of the optical disc 30 as a newest RMD block. Subsequently, the system controller 21 forces the optical-disc drive apparatus 20 to fall into a stand-by state. In the case where the optical disc 30 is ejected from the optical-disc drive apparatus 20 afterward and is inserted thereinto again, the optical-disc drive apparatus 20 reads out the newest RMD block from the RMA of the first recording layer of the optical disc 30 and decides therefrom that the recording-characteristic-improving DC-erased zone extends over the whole of the PCA.

The optical-disc drive apparatus 20 (the system controller 21) suspends the recording-characteristic-improving DC erasure when an instruction for user-data recording, user-data playback, or disc ejection comes from the host apparatus 10. In this case, the system controller 21 detects the position and size of the recording-characteristic-improving DC-erased zone which occurs at the moment of the suspension of the recording-characteristic-improving DC erasure. Then, the system controller 21 generates an updated RMD block (a new RMD block). The system controller 21 loads byte positions of “m” to “m+2” in the updated RMD block with an information piece representing an address equal to the address of the innermost edge of the recording-characteristic-improving DC-erased zone. Furthermore, the system controller 21 loads byte positions of “m+3” to “m+5” in the updated RMD block with an information piece representing an address equal to the address of the outermost edge of the recording-characteristic-improving DC-erased zone. Subsequently, the system controller 21 controls the recording and reproducing circuit 22 and the optical pickup 23 to record the updated RMD block in the RMA of the first recording layer of the optical disc 30 as a newest RMD block.

It should be noted that the above-indicated addresses are obtained from address information stored in the land pre-pits (LPP) of the optical disc 30.

As previously mentioned, the optical-disc drive apparatus 20 (the system controller 21) decides whether or not the recording-characteristic-improving DC-erased zone extends over the whole of the PCA. When it is decided that the recording-characteristic-improving DC-erased zone extends over the whole of the PCA, the optical-disc drive apparatus 20 immediately falls into the stand-by state.

In the case where the optical-disc drive apparatus 20 (the system controller 21) decides that the recording of user data on the optical disc 30 or the playback of user data therefrom has been completed and a new instruction for user-data recording or user-data playback does not come from the host apparatus 10, the optical-disc drive apparatus 20 repeats the sequence of the above-indicated steps starting from the step of reading out disc type information from the lead-in area of the optical disc 30 and deciding the type of the optical disc 30 by referring to the read-out disc type information.

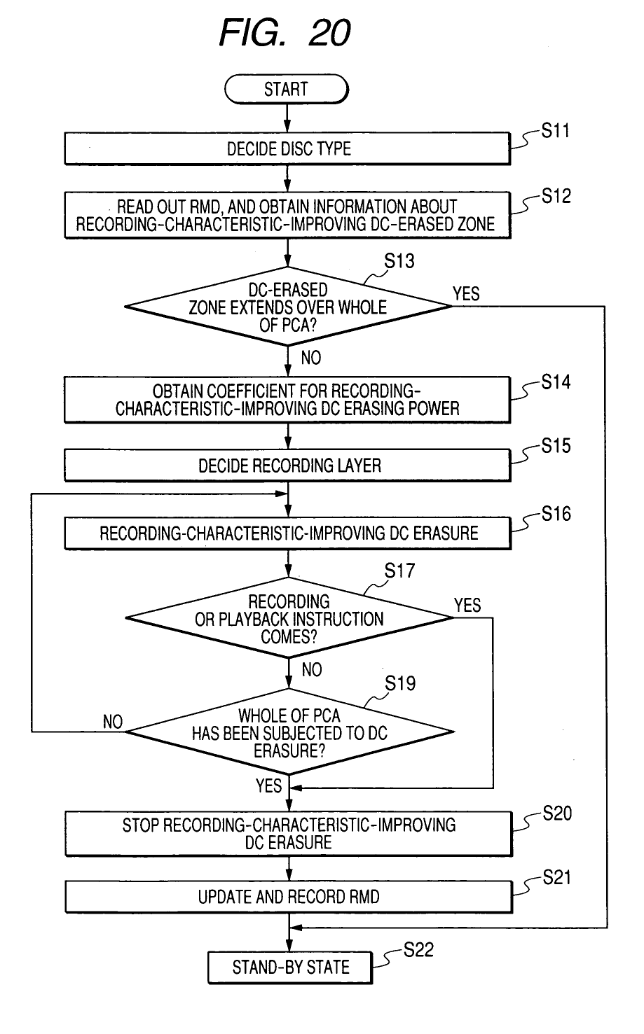

FIG. 20 is a flowchart of a segment of the control program for the optical-disc drive apparatus 20 (the system controller 21). The program segment in FIG. 20 is started when the optical-disc drive apparatus 20 is loaded with an optical disc 30.

As shown in FIG. 20, a first step S11 of the program segment reads out disc type information from the control data zone in the lead-in area of the optical disc 30. The step S11 decides the type of the optical disc 30 by referring to the read-out disc type information.

A step S12 following the step S11 reads out the newest RMD block from the RMA in the first recording layer of the optical disc 30. The step S12 obtains, from the read-out newest RMD block, information of a recording-characteristic-improving DC-erased zone, specifically, information representing the addresses of the innermost and outermost edges of the recording-characteristic-improving DC-erased zone.

A step S13 subsequent to the step S12 compares the addresses of the innermost and outermost edges of the recording-characteristic-improving DC-erased zone with those of the inner and outer circumferences of the PCA in the first recording layer of the optical disc 30. The step S13 decides whether or not the recording-characteristic-improving DC-erased zone extends over the whole of the PCA on the basis of the results of the comparison. When it is decided that the recording-characteristic-improving DC-erased zone extends over the whole of the PCA, the program advances from the step S13 to a step S22. Otherwise, the program advances from the step S13 to a step S14.

The step S14 reads out reference information from the land pre-pits (LPP) or the control data zone in the lead-in area of the optical disc 30. The reference information represents a reference writing power Pwc of a laser beam, a ratio “εc” between a reference erasing power Pec of the laser beam and the reference writing power Pwc thereof, and a coefficient “μ” for a recording-characteristic-improving DC erasing power of the laser beam.

A step S15 following the step S14 focuses the laser beam on the first recording layer of the optical disc 30. After the step S15, the program advances to a step S16.

The step S16 subjects a portion of the PCA in the first recording layer of the optical disc 30 which extends outside the recording-characteristic-improving DC-erased zone to the recording-characteristic-improving DC erasure. The first execution of the step S16 starts the recording-characteristic-improving DC erasure. The step S16 controls the laser beam to scan the above-indicated portion of the PCA, and maintains the power of the laser beam at a value (μ·Pedc) equal to the product of the coefficient “μ” and the ordinary DC erasing power Pedc.

A step S17 following the step S16 checks whether an instruction for user-data recording, user-data playback, or disc ejection comes from the host apparatus 10. When such an instruction comes, the program advances from the step S17 to a step S20. Otherwise, the program advances from the step S17 to a step S19.

The step S19 decides whether or not the whole of the PCA in the first recording layer of the optical disc 30 has been subjected to the recording-characteristic-improving DC erasure. When the whole of the PCA in the first recording layer of the optical disc 30 has been subjected to the recording-characteristic-improving DC erasure, the program advances from the step S19 to a step S20. Otherwise, the program returns from the step S19 to the step S16 so that the recording-characteristic-improving DC erasure will be continued.

The step S20 stops the recording-characteristic-improving DC erasure. After the step S20, the program advances to the step S21.

The step S21 detects the position and size of the recording-characteristic-improving DC-erased zone which occurs at the present moment. The step S21 generates an updated RMD block (a new RMD block) representing the addresses of the innermost and outermost edges of the recording-characteristic-improving DC-erased zone occurring at the present moment. The step S21 records the updated RMD block in the RMA of the first recording layer of the optical disc 30 as a newest RMD block. It should be noted that the recording-characteristic-improving DC-erased zone is expanded by the recording-characteristic-improving DC erasure. After the step S21, the program advances to the step S22.

The step S22 forces the optical-disc drive apparatus 20 to fall into the stand-by state.

The step S13 may decide whether or not the optical disc 30 is virgin, that is, whether or not the optical disc 30 is in an initial state. In this case, when the optical disc 30 is virgin, that is, when the optical disc 30 is in the initial state, the program advances from the step S13 to the step S14. Otherwise, the program jumps from the step S13 to the step S22. Accordingly, in this case, the recording-characteristic-improving DC erasure is performed with respect to a virgin optical disc 30 only. The recording-characteristic-improving DC erasure is prevented from being performed with respect to an optical disc 30 which has been used at least once.

When an instruction for carrying out the OPC procedure comes from the host apparatus 10, the optical-disc drive apparatus 20 moves out of the stand-by state. When deciding to carry out the OPC procedure, the optical-disc drive apparatus 20 moves out of the stand-by state. After moving out of the stand-by state, the optical-disc drive apparatus 20 operates to implement the OPC procedure as follows. First, the optical pickup 23 in the optical-disc drive apparatus 20 reads out the newest RMD block from the RMA in the first recording layer of the optical disc 30 while being controlled by the system controller 21. The read-out RMD block is sent from the optical pickup 23 to the system controller 21 via the recording and reproducing circuit 22. The system controller 21 detects, from the read-out RMD block, an outermost section in an unused zone in the PCA of the first recording layer of the optical disc 30.

Then, the optical-disc drive apparatus 20 sequentially records test signals on a first half of the detected section in the PCA through the use of the optical pickup 23 while changing the writing power Pw of the laser beam among different values (for example, 10 different values). The recorded test signals are assigned to the different values of the writing power Pw of the laser beam, respectively. During the recording of the test signals, the optical-disc drive apparatus 20 maintains the bottom power Pb of the laser beam at a fixed value. Furthermore, the optical-disc drive apparatus 20 changes the erasing power Pe of the laser beam in accordance with the change of the writing power Pw thereof. Specifically, the optical-disc drive apparatus 20 equalizes the erasing power Pe to the product of the writing power Pw and a prescribed value “ε”. The prescribed value “ε” is equal to, for example, 0.5.

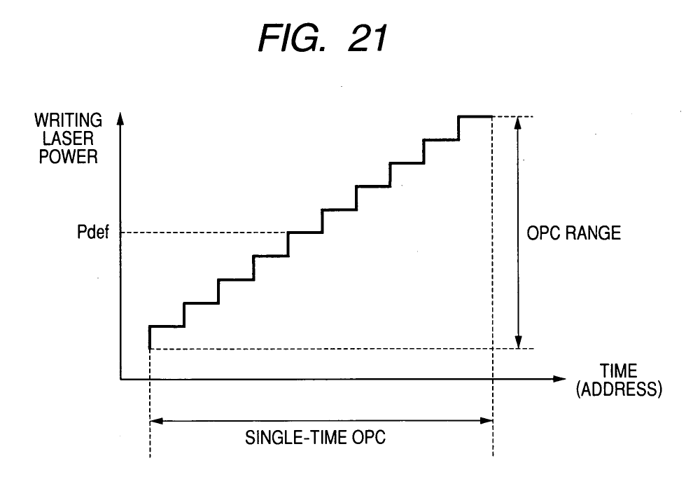

As shown in FIG. 21, a range covering the different values of the writing laser power Pw is called an OPC range. The power value centered at the OPC range is denoted by Pdef. According to a first example, the different power values extend from −30% to +40% decrements or increments with respect to the center value Pdef (that is, from 70% to 140% of the center value Pdef). According to a second example, the different power values are spaced at 1-mW intervals and extend from −4 mW to +5 mW decrements or increments with respect to the center value Pdef.

The optical-disc drive apparatus 20 reproduces the recorded test signals from the optical disc 30 through the use of the optical pickup 23 to obtain reproduced signals corresponding to the different values of the writing laser power Pw respectively. In the optical-disc drive apparatus 20, the reproduced signals are sequentially sent from the optical pickup 23 to the record-condition detecting circuit 28. The record-condition detecting circuit 28 detects the peaks A1, A2, and A3 of each of the reproduced signals. The record-condition detecting circuit 28 informs the system controller 21 of the detected peaks A1, A2, and A3. The system controller 21 calculates the modulation-factor derivative values “γ” of the respective reproduced signals from the detected peaks A1, A2, and A3 thereof. The calculated modulation-factor derivative values “γ” correspond to the different values of the writing laser power Pw, respectively.

The system controller 21 searches the calculated modulation-factor derivative values “γ” for one equal or closest to a prescribed target value “γtarget” (see FIG. 13). Then, the system controller 21 finds, from among the different values of the writing laser power Pw, one corresponding to the calculated modulation-factor derivative value “γ” equal or closest to the prescribed target value “γtarget”. The found power value is denoted by Ptarget (see FIG. 13). The system controller 21 multiplies the power value Ptarget by a prescribed coefficient “ρ”. The system controller 21 labels the result of the multiplication as an optimum writing power Pwo (Pwo=ρ·Ptarget) of the laser beam. In this way, the optimum value Pwo of the writing laser power Pw is decided.

The prescribed target value “γtarget” is equal to, for example, 1.5. The prescribed coefficient “ρ” is equal to, for example, 1.22. Signals representing the prescribed value “ε”, the center value Pdef, the prescribed target value “γtarget”, and the prescribed coefficient “ρ” are portions of the reference information prestored in the LPP or the control data zone of the optical disc 30. In order to obtain the prescribed value “ε”, the center value Pdef, the prescribed target value “γtarget”, and the prescribed coefficient “ρ”, the optical-disc drive apparatus 20 reads out the reference information from the optical disc 30 through the use of the optical pickup 23. The optical-disc drive apparatus 20 may include a nonvolatile memory prestoring reference signals (reference information) representing the prescribed value “ε”, the center value Pdef, the prescribed target value “γtarget”, and the prescribed coefficient “ρ” for each of different disc types. In this case, the optical-disc drive apparatus 20 accesses the nonvolatile memory to obtain the prescribed value “ε”, the center value Pdef, the prescribed target value “γtarget”, and the prescribed coefficient “ρ”.

After the optimum value Pwo of the writing laser power Pw is decided, the optical-disc drive apparatus 20 sequentially records test signals on a second half of the detected section in the PCA through the use of the optical pickup 23 while changing the erasing power Pe of the laser beam among different values (for example, 10 different values). The recorded test signals are assigned to the different values of the erasing power Pe of the laser beam, respectively. During the recording of the test signals, the optical-disc drive apparatus 20 maintains the writing and bottom powers Pw and Pb of the laser beam at the optimum value Pwo and the fixed value respectively.

The optical-disc drive apparatus 20 reproduces the recorded test signals from the optical disc 30 through the use of the optical pickup 23 to obtain reproduced signals corresponding to the different values of the erasing laser power Pe respectively. In the optical-disc drive apparatus 20, the reproduced signals are sequentially sent from the optical pickup 23 to the record-condition detecting circuit 28. The record-condition detecting circuit 28 detects the peaks A1 and A2 of each of the reproduced signals. The record-condition detecting circuit 28 informs the system controller 21 of the detected peaks A1 and A2. The system controller 21 calculates the asymmetry values “β” of the respective reproduced signals from the detected peaks A1 and A2 thereof. The calculated asymmetry values “β” correspond to the different values of the erasing laser power Pe, respectively.

The system controller 21 searches the calculated asymmetry values “β” for one equal or closest to a prescribed target value “βtarget”. Then, the system controller 21 finds, from among the different values of the erasing laser power Pe, one corresponding to the calculated asymmetry value “β” equal or closest to the prescribed target value “βtarget”. The system controller 21 labels the found power value as an optimum erasing power Peo of the laser beam. In this way, the optimum value Peo of the erasing laser power Pe is decided.

The prescribed target value “βtarget” is equal to, for example, 0.04. A signal representing the prescribed target value “βtarget” is a portion of the reference information prestored in the LPP or the control data zone of the optical disc 30. In order to obtain the prescribed target value “βtarget”, the optical-disc drive apparatus 20 reads out the reference information from the optical disc 30 through the use of the optical pickup 23. The optical-disc drive apparatus 20 may include a nonvolatile memory prestoring a signal (reference information) representing the prescribed target value “βtarget” for each of different disc types. In this case, the optical-disc drive apparatus 20 accesses the nonvolatile memory to obtain the prescribed target value “βtarget”.

Finally, the system controller 21 in the optical-disc drive apparatus 20 generates an updated RMD block (a new RMD block) including address information about the section in the PCA which have been used by the this-time OPC procedure. The system controller 21 controls the recording and reproducing circuit 22 and the optical pickup 23 to record the updated RMD block in the RMA of the first recording layer in the optical disc 30 as a newest RMD block.

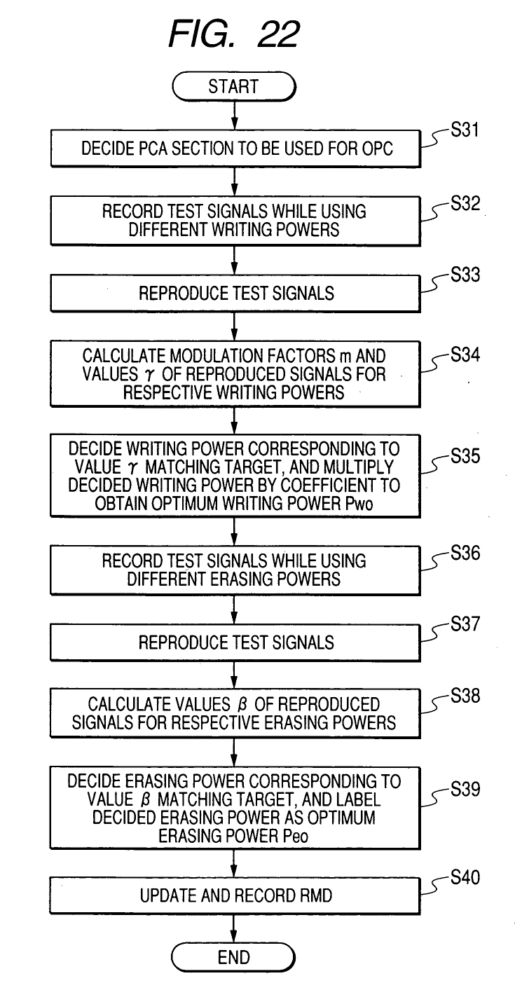

FIG. 22 is a flowchart of another segment of the control program for the optical-disc drive apparatus 20 (the system controller 21). The program segment in FIG. 22 relates to the OPC procedure. The program segment in FIG. 22 is started when the optical-disc drive apparatus 20 is requested or decides to carry out the OPC procedure.

As shown in FIG. 22, a first step S31 of the program segment reads out the newest RMD block from the RMA in the first recording layer of the optical disc 30. The step S31 detects, from the read-out RMD block, an outermost section in an unused zone in the PCA of the first recording layer of the optical disc 30.

A step S32 following the step S31 sequentially records test signals on a first half of the detected section in the PCA while changing the writing power Pw of the laser beam among different values. The recorded test signals are assigned to the different values of the writing power Pw of the laser beam, respectively. During the recording of the test signals, the step S32 maintains the bottom power Pb of the laser beam at a fixed value. Furthermore, the step S32 changes the erasing power Pe of the laser beam in accordance with the change of the writing power Pw thereof. Specifically, the step S32 equalizes the erasing power Pe to the product of the writing power Pw and the prescribed value “ε”.

A step S33 subsequent to the step S32 reproduces the recorded test signals from the optical disc 30 to obtain reproduced signals corresponding to the different values of the writing laser power Pw respectively.

A step S34 following the step S33 detects the peaks A1, A2, and A3 of each of the reproduced signals. The step S34 calculates the modulation-factor derivative values “γ” of the respective reproduced signals from the detected peaks A1, A2, and A3 thereof. The calculated modulation-factor derivative values “γ” correspond to the different values of the writing laser power Pw, respectively.

A step S35 subsequent to the step S34 searches the calculated modulation-factor derivative values “γ” for one equal or closest to the prescribed target value “γtarget”. The step S35 finds, from among the different values of the writing laser power Pw, one corresponding to the calculated modulation-factor derivative value “γ” equal or closest to the prescribed target value “γtarget”. The found power value is denoted by Ptarget. The step S35 multiplies the power value Ptarget by the prescribed coefficient “ρ”. The step S35 labels the result of the multiplication as an optimum writing power Pwo (Pwo=ρ·Ptarget) of the laser beam. Thus, the step S35 decides the optimum value Pwo of the writing laser power Pw.

A step S36 following the step S35 sequentially records test signals on a second half of the selected section in the PCA while changing the erasing power Pe of the laser beam among different values. The recorded test signals are assigned to the different values of the erasing power Pe of the laser beam, respectively. During the recording of the test signals, the step S36 maintains the writing and bottom powers Pw and Pb of the laser beam at the optimum value Pwo and the fixed value respectively.

A step S37 subsequent to the step S36 reproduces the recorded test signals from the optical disc 30 to obtain reproduced signals corresponding to the different values of the erasing laser power Pe respectively.

A step S38 following the step S37 detects the peaks A1 and A2 of each of the reproduced signals. The step S38 calculates the asymmetry values “β” of the respective reproduced signals from the detected peaks A1 and A2 thereof. The calculated asymmetry values “β” correspond to the different values of the erasing laser power Pe, respectively.

A step S39 subsequent to the step S38 searches the calculated asymmetry values “β” for one equal or closest to the prescribed target value “βtarget”. Then, the step S39 finds, from among the different values of the erasing laser power Pe, one corresponding to the calculated asymmetry value “β” equal or closest to the prescribed target value “βtarget”. The step S39 labels the found power value as an optimum erasing power Peo of the laser beam. Thus, the step S39 decides the optimum value Peo of the erasing laser power Pe.

A step S40 following the step S39 generates an updated RMD block (a new RMD block) including address information about the section in the PCA which have been used by the this-time OPC procedure. The step S40 records the updated RMD block in the RMA of the first recording layer in the optical disc 30 as a newest RMD block. After the step S40, the current execution cycle of the program segment ends.

During the recording of user data on the data area in the first recording layer of the optical disc 30, the optical-disc drive apparatus 20 controls the writing and erasing powers Pw and Pe of the laser beam at the decided optimum values Pwo and Peo respectively.

As the OPC procedure is iterated with respect to a same optical disc 30, a usable zone in a PCA of the optical disc 30 decreases. Finally, the usable zone disappears from the PCA. In this case, the optical-disc drive apparatus 20 subjects the PCA to the ordinary DC erasure by using the laser beam having the ordinary DC erasing power Pedc. As a result of the ordinary DC erasure, the PCA returns to a usable state again. The ordinary DC erasing power Pedc is equal to or slightly greater than the product of the reference writing power Pwc and the ratio “εc”.

In general, the optical-disc drive apparatus 20 subjects the whole of the PCA in the first recording layer of an optical disc 30 to the recording-characteristic-improving DC erasure. Alternatively, the optical-disc drive apparatus 20 may subject only an outer portion of the PCA to the recording-characteristic-improving DC erasure. The outer portion extends from the outer circumference of the PCA to a suitable position. Since only the outer portion of the PCA is subjected to the recording-characteristic-improving DC erasure, a time taken by the recording-characteristic-improving DC erasure can be shorter.

There is a case where immediately after the optical-disc drive apparatus 20 is loaded with a virgin optical disc 30, an instruction for recording user data comes from the host apparatus 10. In this case, the optical-disc drive apparatus 20 implements the OPC procedure with respect to the virgin optical disc 30 before carrying out the recording of user data thereon. Preferably, the optical-disc drive apparatus 20 subjects only an outer portion of the PCA in the first recording layer of the virgin optical disc 30 to the recording-characteristic-improving DC erasure. The outer portion extends from the outer circumference of the PCA to a specified position, and has a size just used by the single-time OPC procedure. After the recording-characteristic-improving DC erasure, the optical-disc drive apparatus 20 implements the OPC procedure by using the outer portion of the PCA. Thus, it is possible to shorten a time from the moment of loading the optical-disc drive apparatus 20 with the virgin optical disc 30 to the moment of the start of the recording of user data on the virgin optical disc 30. In the case where the optical-disc drive apparatus 20 decides that an instruction for user-data recording or user-data playback will not come from the host apparatus 10 thereafter, the optical-disc drive apparatus 20 subjects the remaining portion of the PCA in the first recording layer of the virgin optical disc 30 to the recording-characteristic-improving DC erasure.

As previously mentioned, the optical-disc drive apparatus 20 performs the recording-characteristic-improving DC erasure with respect to the PCA in the first recording layer of the optical disc 30. The recording-characteristic-improving DC erasure enables the modulation factors “m” and the asymmetry values “β” of reproduced signals to be substantially independent of the number of times of signal recording on the optical disc 30. Therefore, the optimum writing and erasing values Pwo and Peo of the laser beam can be accurately and reliably decided regardless of the number of times of signal recording on the optical disc 30. The optical-disc drive apparatus 20 records user data on the optical disc 30 while using the laser beam having the writing and erasing powers Pw and Pe equal to the optimum values Pwo and Peo respectively. The optical-disc drive apparatus 20 reproduces the user data from the optical disc 30. The reproduced user data is small in error rate, and good in quality.

Preferably, the optical-disc drive apparatus 20 decides whether or not the optical disc 30 is virgin, that is, whether or not the optical disc 30 is in an initial state. Depending on the result of this decision, the optical-disc drive apparatus 20 selectively performs or does not perform the recording-characteristic-improving DC erasure with respect to the optical disc 30. Specifically, the optical-disc drive apparatus 20 performs the recording-characteristic-improving DC erasure only once or twice with respect to the optical disc 30 which is virgin or in the initial state. The optical-disc drive apparatus 20 does not perform the recording-characteristic-improving DC erasure with respect to the optical disc 30 in other conditions.

### Second Embodiment

A second embodiment of this invention is similar to the first embodiment thereof except for design changes mentioned hereafter. According to the second embodiment of this invention, the optical-disc drive apparatus 20 does not perform the recording-characteristic-improving DC erasure with respect to the PCA in the first recording layer of a virgin optical disc 30. The optical-disc drive apparatus 20 implements the OPC procedure while using each of usable sections in the PCA of the first recording layer of an optical disc 30. When the PCA in the optical disc 30 has been used up, the optical-disc drive apparatus 20 performs the recording-characteristic-improving DC erasure with respect to the PCA to return the PCA to a usable state. Thereafter, the optical-disc drive apparatus 20 implements the OPC procedure while using each of usable sections in the PCA of the optical disc 30. When the PCA in the optical disc 30 has been used up, the optical-disc drive apparatus 20 performs the ordinary DC erasure with respect to the PCA to return the PCA to the usable state.

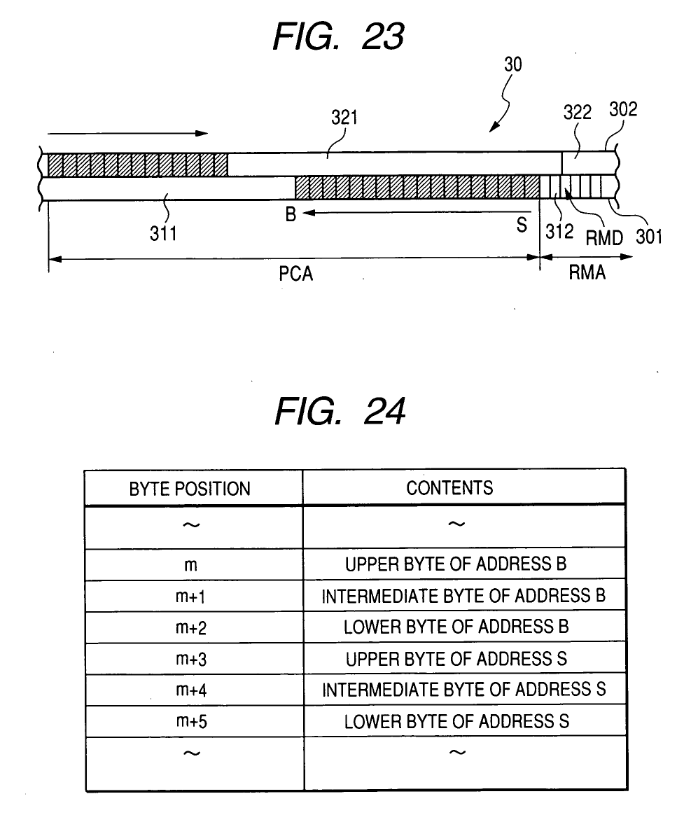

FIG. 23 shows the conditions of the R-information areas in the first and second recording layers 301 and 302 of an optical disc 30 which occur after the OPC procedure has been performed by utilizing each of the PCAs 311 and 321 many times. In FIG. 23, the hatched rectangles denote PCA sections which have been used for the OPC procedure. The used sections in the PCA 311 constitute a used zone therein. The used sections in the PCA 321 constitute a used zone therein. With reference to FIG. 23, the innermost edge of the used zone in the PCA 311 of the first recording layer 301 and the outermost edge of the used zone in the PCA 321 of the second recording layer 302 are close to each other so that the PCAs 311 and 321 can not be further used for the OPC procedure. In this case, when the OPC procedure using the PCA 311 is required to be performed, the optical-disc drive apparatus 20 subjects the used zone in the PCA 311 to the recording-characteristic-improving DC erasure to return the used zone to a usable state.

Before the start of the recording-characteristic-improving DC erasure, the optical pickup 23 reads out a newest RMD block from the RMA 312 in the first recording layer 301 of the optical disc 30 while being controlled by the system controller 23. The read-out RMD block is sent from the optical pickup 23 to the system controller 23 via the recording and reproducing circuit 22. In the newest RMD block within the RMA 312 of the optical disc 30 which has not been subjected to the recording-characteristic-improving DC erasure, byte positions of “m” to “m+5” store “00h”.

The system controller 21 decides whether or not byte positions of “m” to “m+5” in the read-out RMD block store “00h”. When byte positions of “m” to “m+5” store “00h”, the system controller 21 concludes that the optical disc 30 has not been subjected to the recording-characteristic-improving DC erasure. Then, the optical-disc drive apparatus 20 operates as follows.

The optical pickup 23 reads out the reference information from the land pre-pits (LPP) or the control data zone in the lead-in area of the optical disc 30 while being controlled by the system controller 21. The reference information represents the reference writing power Pwc of the laser beam, the ratio “εc” between the reference erasing power Pec of the laser beam and the reference writing power Pwc thereof, and the coefficient “μ” for the recording-characteristic-improving DC erasing power of the laser beam. The read-out reference information is sent from the optical pickup 23 to the system controller 21 via the recording and reproducing circuit 22. The system controller 21 derives the coefficient “μ” from the read-out reference information. The system controller 21 multiplies the ordinary DC erasing power Pedc by the coefficient “μ” to calculate the recording-characteristic-improving DC erasing power (μ·Pedc). Then, the optical-disc drive apparatus 20 subjects the used zone in the PCA 311 of the first recording layer 301 of the optical disc 30 to the recording-characteristic-improving DC erasure. During the recording-characteristic-improving DC erasure, the optical-disc drive apparatus 20 controls the laser beam to scan the used zone in the PCA 311 in a direction from its inner circumference to its outer circumference, and maintains the power of the laser beam at the calculated value (μ·Pedc). Generally, the address of the innermost section in the used zone is derived from the RMD block read out from the RMA 312. In some cases, the RMD block fails to store address information about a latest used section in the PCA 311. Accordingly, it is preferable that after the address of the innermost section in the used zone is derived from the RMD block, the optical-disc drive apparatus 20 checks whether or not a used section is present in the PCA 311 inward of the above innermost section. When a used section is present inward of the innermost section, the optical-disc drive apparatus 20 uses the address of the used section as an indication of the inner circumference of the used zone in the PCA 311. In FIG. 23, the letter B denotes the address of the innermost section in the used zone in the PCA 311, and the letter S denotes the address of the outermost section in the used zone in the PCA 311 which agrees with the address of the outer circumference of the PCA 311.

When the outermost section in the used zone in the PCA 311 has been subjected to the recording-characteristic-improving DC erasure, the system controller 21 generates an updated RMD block (a new RMD block). The system controller 21 loads byte positions of “m” to “m+5” in the updated RMD block with an information piece representing an address equal to the address B (see FIG. 23) and an information piece representing an address equal to the address S (see FIG. 23). Then, the system controller 21 controls the recording and reproducing circuit 22 and the optical pickup 23 to record the updated RMD block in the RMA of the first recording layer of the optical disc 30 as a newest RMD block.

As shown in FIG. 24, byte positions of “m”, “m+1”, and “m+2” in the updated RMD block store the upper, intermediate, and lower bytes of the address B respectively. Byte positions of “m+3”, “m+4”, and “m+5” in the updated RMD block store the upper, intermediate, and lower bytes of the address S. The recording-characteristic-improving DC erasure changes the used zone in the PCA 311 to the recording-characteristic-improving DC-erased zone having innermost and outermost edges at the addresses S and B respectively (see FIG. 23). Thus, byte positions of “m”, “m+1”, and “m+2” in the updated RMD block store the address of the innermost edge of the recording-characteristic-improving DC-erased zone. On the other hand, byte positions of “m+3”, “m+4”, and “m+5” in the updated RMD block store the address of the outermost edge of the recording-characteristic-improving DC-erased zone.

As a result of the recording-characteristic-improving DC erasure, the used zone in the PCA 311 returns to a usable state and hence the PCA 311 can be used for the OPC procedure again.

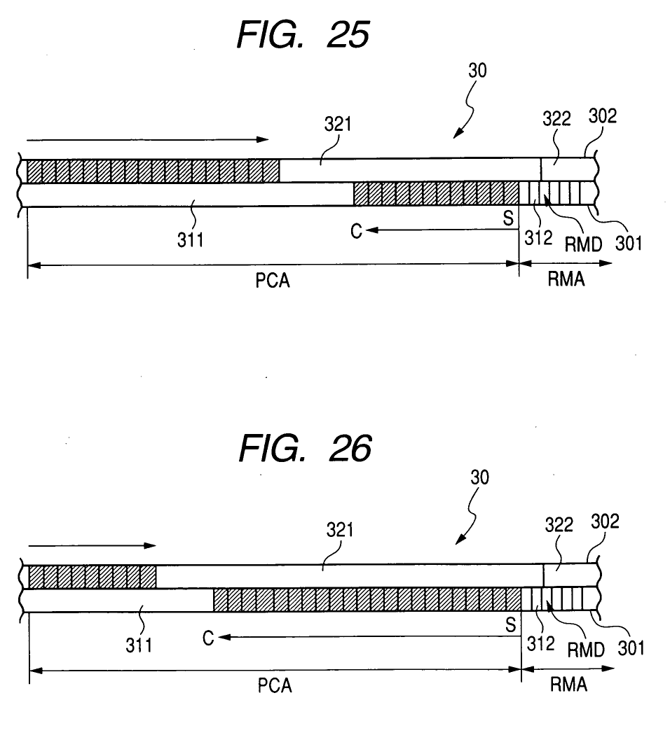

FIG. 25 shows the conditions of the R-information areas in the first and second recording layers 301 and 302 of the optical disc 30 which occur after the PCA 311 has been subjected to the recording-characteristic-improving DC erasure as mentioned above and then the OPC procedure has been performed by utilizing each of the PCAs 311 and 321 many times. In FIG. 25, the hatched rectangles denote PCA sections which have been used for the OPC procedure. The used sections in the PCA 311 constitute a used zone therein. The used sections in the PCA 321 constitute a used zone therein. In FIG. 25, the letter C denotes the address of the innermost section in the used zone in the PCA 311, and the letter S denotes the address of the outermost section in the used zone in the PCA 311 which agrees with the address of the outer circumference of the PCA 311. With reference to FIG. 25, the innermost edge of the used zone in the PCA 311 of the first recording layer 301 and the outermost edge of the used zone in the PCA 321 of the second recording layer 302 are close to each other so that the PCAs 311 and 321 can not be further used for the OPC procedure. In this case, when the OPC procedure using the PCA 311 is required to be performed, the optical-disc drive apparatus 20 subjects the used zone in the PCA 311 to the ordinary DC erasure or a combination of the ordinary DC erasure and the recording-characteristic-improving DC erasure to return the used zone to the usable state.

Before the start of the ordinary DC erasure or a combination of the ordinary DC erasure and the recording-characteristic-improving DC erasure, the optical pickup 23 reads out a newest RMD block from the RMA 312 in the first recording layer 301 of the optical disc 30 while being controlled by the system controller 21. The read-out RMD block is sent from the optical pickup 23 to the system controller 21 via the recording and reproducing circuit 22. The system controller 21 derives the addresses (the addresses B and S) of the innermost and outermost edges of the recording-characteristic-improving DC-erased zone from byte positions of “m” to “m+5” in the read-out RMD block. The system controller 21 compares the addresses (the addresses B and S) of the innermost and outermost edges of the recording-characteristic-improving DC-erased zone with the addresses (the addresses C and S) of the present used zone in the PCA 311 respectively. The system controller 21 refers to the results of the comparison, and thereby decides whether or not the whole of the present used zone (between the addresses C and S) is contained in the recording-characteristic-improving DC-erased zone (between the addresses B and S). When it is decided that the whole of the present used zone is contained in the recording-characteristic-improving DC-erased zone, the optical-disc drive apparatus 20 subjects the present used zone in the PCA 311 to the ordinary DC erasure. As previously mentioned, the ordinary DC erasure uses the laser beam having the ordinary DC erasing power Pedc. When it is decided that the whole of the present used zone is not contained in the recording-characteristic-improving DC-erased zone, the optical-disc drive apparatus 20 subjects the present used zone in the PCA 311 to a combination of the ordinary DC erasure and the recording-characteristic-improving DC erasure.

FIG. 26 shows the conditions of the R-information areas in the first and second recording layers 301 and 302 of the optical disc 30 in which the whole of the present used zone (between the addresses C and S) is not contained in the recording-characteristic-improving DC-erased zone (between the addresses B and S). Specifically, in FIG. 26, the position at the address C exists inward of the position at the address B. In this case, the optical pickup 23 reads out the reference information from the land pre-pits (LPP) or the control data zone in the lead-in area of the optical disc 30 while being controlled by the system controller 21. The reference information represents the reference writing power Pwc of the laser beam, the ratio “εc” between the reference erasing power Pec of the laser beam and the reference writing power Pwc thereof, and the coefficient “μ” for the recording-characteristic-improving DC erasing power of the laser beam. The read-out reference information is sent from the optical-pickup 23 to the system controller 21 via the recording and reproducing circuit 22. The system controller 21 derives the coefficient “μ” from the read-out reference information. The system controller 21 multiplies the ordinary DC erasing power Pedc by the coefficient “μ” to calculate the recording-characteristic-improving DC erasing power (μ·Pedc). Then, the optical-disc drive apparatus 20 subjects the used zone between the addresses C and B in the PCA 311 to the recording-characteristic-improving DC erasure. During the recording-characteristic-improving DC erasure, the optical-disc drive apparatus 20 maintains the power of the laser beam at the calculated value (μ·Pedc). After the recording-characteristic-improving DC erasure has been completed, the optical-disc drive apparatus 20 subjects the used zone between the addresses B and S in the PCA 311 to the ordinary DC erasure. During the ordinary DC erasure, the optical-disc drive apparatus 20 maintains the power of the laser beam at the given value Pedc.

Reference data (reference information) representing not only the target asymmetry value “βtarget” but also a target asymmetry value ”βtarget1” is prerecorded on the LPP or the control data zone in the lead-in area of the first recording layer of an optical disc 30. The target asymmetry value “βtarget1” is designed for the OPC procedure performed with respect to a section in the PCA 311 of the first recording layer of the optical disc 30 which has never been used. On the other hand, the target asymmetry value “βtarget” is designed for the OPC procedure performed with respect to a section in the PCA 311 which has been used.

The optical pickup 23 reads out the reference data from an optical disc 30 while being controlled by the system controller 21. The read-out reference data is sent from the optical pickup 23 to the system controller 21 via the recording and reproducing circuit 22. The system controller 21 derives the target asymmetry values “βtarget” and “βtarget1” from the read-out reference data. During the OPC procedure performed with respect to a section in the PCA 311 of the first recording layer of the optical disc 30 which has never been used, the optical-disc drive apparatus 20 utilizes the target asymmetry value “βtarget1” in deciding an optimum writing power Pwo of the laser beam. During the OPC procedure performed with respect to a section in the PCA 311 of the optical disc 30 which has been used, the optical-disc drive apparatus 20 utilizes the target asymmetry value “βtarget” in deciding an optimum writing power Pwo of the laser beam. The optical-disc drive apparatus 20 decides an optimum erasing power Peo of the laser beam in a way similar to that of the decision of the optimum writing power Pwo.

As understood from the above description, the optical-disc drive apparatus 20 does not perform the recording-characteristic-improving DC erasure with respect to the PCA in the first recording layer of a virgin optical disc 30. When the PCA in the first recording layer of the optical disc 30 has been substantially used up, the optical-disc drive apparatus 20 performs the recording-characteristic-improving DC erasure with respect thereto.

The recording-characteristic-improving DC erasure enables the modulation factors “m” and the asymmetry values “β” of reproduced signals to be substantially independent of the number of times of signal recording on the optical disc 30. Therefore, the optimum writing and erasing values Pwo and Peo of the laser beam can be accurately and reliably decided regardless of the number of times of signal recording on the optical disc 30. The optical-disc drive apparatus 20 records user data on the optical disc 30 while using the laser beam having the writing and erasing powers Pw and Pe equal to the optimum values Pwo and Peo respectively. The optical-disc drive apparatus 20 reproduces the user data from the optical disc 30. The reproduced user data is small in error rate, and good in quality.

During the manufacture of an optical disc 30, reference data (reference information) related to a laser power for the recording-characteristic-improving DC erasure is recorded on the optical disc 30. Even in the case of a new-product optical disc 30 on the market, reference data can be reproduced therefrom and utilized. Thus, it is possible to attain a high convenience in use.

Preferably, the optical-disc drive apparatus 20 decides whether or not the optical disc 30 has undergone data recording only once since its virgin or initial state. Depending on the result of this decision, the optical-disc drive apparatus 20 selectively performs or does not perform the recording-characteristic-improving DC erasure with respect to the optical disc 30. Specifically, the optical-disc drive apparatus 20 performs the recording-characteristic-improving DC erasure with respect to the optical disc 30 which has undergone data recording only once since its virgin or initial state. The optical-disc drive apparatus 20 does not perform the recording-characteristic-improving DC erasure with respect to the optical disc 30 in other conditions.

### Third Embodiment

A third embodiment of this invention is similar to the first or second embodiment thereof except for design changes mentioned hereafter.

According to the third embodiment of this invention, the optical-disc drive apparatus 20 performs the recording-characteristic-improving DC erasure with respect to not only the PCA but also the data area in the first recording layer of an optical disc 30.

While being loaded with an optical disc 30, the optical-disc drive apparatus 20 receives from the host apparatus 10 an instruction for performing the recording-characteristic-improving DC erasure with respect to the data area in the first recording layer of the optical disc 30. The instruction is of either a first type for performing the recording-characteristic-improving DC erasure with respect to the whole of the data area or a second type for performing the recording-characteristic-improving DC erasure with respect to only an inner portion of the data area.

In general, important information such as file system information is recorded on an inner portion of the data area in the first recording layer of an optical disc 30. Performing the recording-characteristic-improving DC erasure with respect to only the inner portion of the data area takes a shorter time, and can prevent the occurrence of the trouble that a file system becomes difficult to reproduce and all recorded data becomes difficult to read out.

When receiving from the host apparatus 10 an instruction for performing the recording-characteristic-improving DC erasure, the optical-disc drive apparatus 20 reads out a newest RMD block from the RMA in the first recording layer of the optical disc 30 through the use of the optical pickup 23. Usually, byte positions of “k” to “k+5” in the read-out RMD block store address information about a recording-characteristic-improving DC-erased zone in the data area of the first recording layer in the optical disc 30. In the case where the optical disc 30 is virgin, an RMD block is absent therefrom or present therein. In this case, byte positions of “k” to “k+5” in the recorded RMD block store “00h”. The data store format of the RMD block is similar to that in FIG. 15 or FIG. 24. The read-out RMD block is sent from the optical pickup 23 to the system controller 21 via the recording and reproducing circuit 22.

The system controller 21 in the optical-disc drive apparatus 20 decides whether or not byte positions of “k” to “k+5” in the read-out RMD block store “00h”. When it is decided that byte positions of “k” to “k+5” in the read-out RMD block store “00h”, the optical pickup 23 reads out the reference information from the land pre-pits (LPP) or the control data zone in the lead-in area of the optical disc 30 while being controlled by the system controller 21. The reference information represents the reference writing power Pwc of the laser beam, the ratio “εc” between the reference erasing power Pec of the laser beam and the reference writing power Pwc thereof, and the coefficient “μ” for the recording-characteristic-improving DC erasing power of the laser beam. The read-out reference information is sent from the optical pickup 23 to the system controller 21 via the recording and reproducing circuit 22. The system controller 21 derives the coefficient “μ” from the read-out reference information. The system controller 21 multiplies the ordinary DC erasing power Pedc by the coefficient “μ” to calculate the recording-characteristic-improving DC erasing power (μ·Pedc). Then, the optical-disc drive apparatus 20 subjects the data area in the first recording layer of the optical disc 30 to the recording-characteristic-improving DC erasure. During the recording-characteristic-improving DC erasure, the optical-disc drive apparatus 20 controls the laser beam to scan the data area in a direction from its inner circumference to its outer circumference, and maintains the power of the laser beam at the calculated value (μ·Pedc).

Each time the recording-characteristic-improving DC erasure with respect to a predetermined-size region in the data area of the first recording layer of the optical disc 30 has been completed, the system controller 21 generates an updated RMD block (a new RMD block). The system controller 21 loads byte positions of “k” to “k+2” in the updated RMD block with an information piece representing the address from which the exposure to the recording-characteristic-improving DC erasure starts. Furthermore, the system controller 21 loads byte positions of “k+3” to “k+5” in the updated RMD block with an information piece representing the address of the predetermined-size region. Then, the system controller 21 controls the recording and reproducing circuit 22 and the optical pickup 23 to record the updated RMD block in the RMA of the first recording layer of the optical disc 30 as a newest RMD block. Thus, in the event that the power supply to the optical-disc drive apparatus 20 fails, it is possible to save address information about the recording-characteristic-improving DC-erased zone in the data area which occurs immediately before the power failure.

When the recording-characteristic-improving DC erasure with respect to the data area of the first recording layer of the optical disc 30 which is instructed by the host apparatus 10 has been completed, the system controller 21 generates an updated RMD block (a new RMD block). The system controller 21 loads byte positions of “k” to “k+2” in the updated RMD block with an information piece representing the address from which the exposure to the recording-characteristic-improving DC erasure starts. Furthermore, the system controller 21 loads byte positions of “k+3” to “k+5” in the updated RMD block with an information piece representing the address at which the exposure to the recording-characteristic-improving DC erasure ends. Thus, byte positions of “k” to “k+5” in the updated RMD block store information representing the start address and the end address of the recording-characteristic-improving DC-erased zone in the data area of the first recording layer of the optical disc 30. Then, the system controller 21 controls the recording and reproducing circuit 22 and the optical pickup 23 to record the updated RMD block in the RMA of the first recording layer of the optical disc 30 as a newest RMD block. The system controller 21 controls the interface 27 to notify the host apparatus 10 that the instructed recording-characteristic-improving DC erasure has been completed.

In the case where the optical disc 30 is ejected from the optical-disc drive apparatus 20 afterward and is inserted thereinto again, the optical-disc drive apparatus 20 operates as mentioned below when receiving from the host apparatus 10 an instruction for performing the recording-characteristic-improving DC erasure with respect to the data area in the first recording layer of the optical disc 30. First, the optical pickup 23 reads out a newest RMD block from the RMA in the first recording layer of the optical disc 30 while being controlled by the system controller 21. The read-out RMD block is sent from the optical pickup 23 to the system controller 21 via the recording and reproducing circuit 22. The system controller 21 derives, from byte positions of “k” to “k+5” in the read-out RMD block, address information about the recording-characteristic-improving DC-erased zone in the data area of the first recording layer of the optical disc 30. The derived information represents the start address and the end address of the recording-characteristic-improving DC-erased zone in the data area. The system controller 21 extracts the start address and the end address of a zone to be subjected to the recording-characteristic-improving DC erasure from the received host-apparatus instruction. The zone to be subjected to the recording-characteristic-improving DC erasure is called the instructed zone. The system controller 21 compares the start address and the end address of the recording-characteristic-improving DC-erased zone with those of the instructed zone. The system controller 21 refers to the results of the comparison, and thereby decides whether or not the whole of the instructed zone is contained in the recording-characteristic-improving DC-erased zone. When it is decided that the whole of the instructed zone is contained in the recording-characteristic-improving DC-erased zone, the system controller 21 controls the interface 27 to inform the host apparatus 10 accordingly. On the other hand, when it is decided that the whole of the instructed zone is not contained in the recording-characteristic-improving DC-erased zone, the optical-disc drive apparatus 20 performs the recording-characteristic-improving DC erasure with respect to only a portion of the instructed zone which extends outside the recording-characteristic-improving DC-erased zone.

The optical-disc drive apparatus 20 subjects the PCA in the first recording layer of the optical disc 30 to the recording-characteristic-improving DC erasure as in the first or second embodiment of this invention. Thereafter, the optical-disc drive apparatus 20 carries out the OPC procedure using the PCA in the first recording layer of the optical disc 30 to decide the optimum writing and erasing laser powers Pwo and Peo. Then, the optical-disc drive apparatus 20 performs the recording of user data on the data area in the first recording layer of the optical disc 30 while using the laser beam having the optimum writing and erasing powers Pwo and Peo. When the recorded user data is requested to be deleted from the data area in the first recording layer of the optical disc 30, the optical-disc drive apparatus 20 subjects the data area to the ordinary DC erasure using the laser beam having the ordinary DC erasing power Pedc.

The recording-characteristic-improving DC erasure performed with respect to the data area in the first recording layer of the optical disc 30 enables the recording/reproduction-related characteristics of the data area to be substantially independent of the number of times of signal recording thereon. Therefore, reliable recording of user data on the data area in the first recording layer of the optical disc 30 can be implemented regardless of the number of times of signal recording thereon.

As previously mentioned, the recording-characteristic-improving DC erasure is performed with respect to not only the PCA but also the data area in the first recording layer of the optical disc 30. Thereby, reliable recording of user data on the data area in the first recording layer of the optical disc 30 can be implemented regardless of the number of times of signal recording thereon. The user data reproduced from the data area in the first recording layer of the optical disc 30 is small in error rate, and good in quality.

It should be noted that the optical-disc drive apparatus 20 may be modified to operate as follows. After recording user data on a zone in the data area of the first recording layer of an optical disc 30 in an initial state, the optical-disc drive apparatus 20 performs the recording-characteristic-improving DC erasure with respect to an inner-circumference-side region in the data area which includes the above zone.

### Fourth Embodiment

A fourth embodiment of this invention is similar to one of the first to third embodiments thereof except for design changes mentioned hereafter.

According to the fourth embodiment of this invention, reference data (reference information) representing a desired value of the power of the laser beam for the recording-characteristic-improving DC erasure is prerecorded on an optical disc 30. The optical-disc drive apparatus 20 reads out the reference data from the optical disc 30, and derives the desired laser power value for the recording-characteristic-improving DC erasure from the read-out reference data. During the recording-characteristic-improving DC erasure, the optical-disc drive apparatus 20 controls the power of the laser beam at the desired value.

### Fifth Embodiment

A fifth embodiment of this invention is similar to one of the first to third embodiments thereof except for design changes mentioned hereafter.

According to the fifth embodiment of this invention, the optical-disc drive apparatus 20 subjects the PCA or the data area in the first recording layer of the optical disc 30 to the recording-characteristic-improving DC erasure twice or thrice.

### Sixth Embodiment

A sixth embodiment of this invention is similar to one of the first to third embodiments thereof except for design changes mentioned hereafter.

According to the sixth embodiment of this invention, the optical-disc drive apparatus 20 includes a nonvolatile memory storing reference information representing the reference writing power Pwc of the laser beam, the ratio “εc” between the reference erasing power Pec of the laser beam and the reference writing power Pwc thereof, and the ordinary DC erasing power Pedc which are experimentally predetermined for each of different disc types. The system controller 21 reads out from the nonvolatile memory the reference information corresponding to the type of an optical disc 30 placed in the optical-disc drive apparatus 20. The system controller 21 derives the reference writing power Pwc, the ratio “εc”, and the ordinary DC erasing power Pedc from the read-out reference information, and then utilizes the derived values. In the event that the reference information corresponding to the type of the optical disc 30 placed in the optical-disc drive apparatus 20 is absent from the nonvolatile memory, the optical pickup 23 reads out reference information from the LPP or the control data zone in the lead-in area of the optical disc 30 while being controlled by the system controller 21. The system controller 21 derives the reference writing power Pwc, the ratio “εc”, and the ordinary DC erasing power Pedc from the read-out reference information, and then utilizes the derived values.

### Seventh Embodiment

A seventh embodiment of this invention is similar to one of the first to third embodiments thereof except for design changes mentioned hereafter.

According to the seventh embodiment of this invention, the optical-disc drive apparatus 20 includes a nonvolatile memory storing reference information representing the coefficient “μ” for the recording-characteristic-improving DC erasing power of the laser beam or a desired value of the power of the laser beam for the recording-characteristic-improving DC erasure which is experimentally predetermined for each of different disc types. The system controller 21 reads out from the nonvolatile memory the reference information corresponding to the type of an optical disc 30 placed in the optical-disc drive apparatus 20. The system controller 21 derives the coefficient “μ” or the desired laser power value for the recording-characteristic-improving DC erasure from the read-out reference information, and then utilizes the derive value. In the event that the reference information corresponding to the type of the optical disc 30 placed in the optical-disc drive apparatus 20 is absent from the nonvolatile memory, the optical pickup 23 reads out reference information from the LPP or the control data zone in the lead-in area of the optical disc 30 while being controlled by the system controller 21. The system controller 21 derives the coefficient “μ” or the desired laser power value for the recording-characteristic-improving DC erasing power from the read-out reference information, and then utilizes the derive value.

### Eighth Embodiment

An eighth embodiment of this invention is similar to one of the first to third embodiments thereof except for design changes mentioned hereafter.

According to the eighth embodiment of this invention, the optical-disc drive apparatus 20 generates an information piece representing whether or not a predetermined zone in the PCA of the first recording layer in the optical disc 30 has been subjected to the recording-characteristic-improving DC erasure. The optical-disc drive apparatus 20 loads an RMD block with the generated information piece before recording the RMD block on the optical disc 30. A first example of the predetermined zone is the whole of the PCA. A second example of the predetermined zone is an outer portion of the PCA.

In the case where an optical disc 30 is ejected from the optical-disc drive apparatus 20 and is inserted thereinto again, the optical pickup 23 reads out a newest RMD block from the optical disc 30 while being controlled by the system controller 21. The system controller 21 derives, from the read-out RMD block, an information piece representing whether or not the predetermined zone in the PCA of the first recording layer in the optical disc 30 has been subjected to the recording-characteristic-improving DC erasure. When the derived information piece represents that the predetermined zone has been subjected to the recording-characteristic-improving DC erasure, the optical-disc drive apparatus 20 does not perform the recording-characteristic-improving DC erasure with respect to the optical disc 30. Otherwise, the optical-disc drive apparatus 20 performs the recording-characteristic-improving DC erasure with respect to the optical disc 30.

### Ninth Embodiment

A ninth embodiment of this invention is similar to one of the first to third embodiments thereof except for design changes mentioned hereafter.

According to the ninth embodiment of this invention, a set of a reference writing power Pwc of a laser beam, a ratio “εc” between a reference erasing power Pec of the laser beam and the reference writing power Pwc thereof, and a coefficient “μ” for a recording-characteristic-improving DC erasing power of the laser beam is prepared for each of setting linear velocities, that is, setting relative speeds between an optical disc 30 and the laser beam during the scanning of the optical disc 30 by the laser beam. Reference information representing the above set is prerecorded on the LPP or the control data zone in the lead-in area of the optical disc 30.

The optical pickup 23 reads out the reference information from the optical disc 30 while being controlled by the system controller 21. The system controller 21 derives the reference writing power Pwc, the ratio “εc”, and the coefficient “μ” for each of the setting linear velocities from the read-out reference information. The system controller 21 calculates a recording-characteristic-improving DC erasing power of the laser beam from the reference writing power Pwc, the ratio “εc”, and the coefficient “μ” for each of the setting linear velocities. The coefficient “μ” may be fixed independent of the setting linear velocities.

### Tenth Embodiment

A tenth embodiment of this invention is similar to one of the first to ninth embodiments thereof except for design changes mentioned hereafter.

The tenth embodiment of this invention is designed to deal with a case where recorded information tends to be erased from the RMA in the first recording layer of a DVD-RW 30 (an optical disc 30) when new user data is written over old user data in the data area in the first recoding layer of the DVD-RW 30.

The system controller 21 saves the address information about the recording-characteristic-improving DC-erased zone into the data memory 25. After new user data is written over old user data in the data area in the first recoding layer of the DVD-RW 30, the system controller 21 operates to send the address information from the data memory 25 to the optical pickup 23 via the recording and reproducing circuit 22. The optical pickup 23 records the address information on the RMA in the first recording layer of the DVD-RW 30 as a part of an RMD block while being controlled by the system controller 21.

### Eleventh Embodiment

An eleventh embodiment of this invention is similar to the first to tenth embodiments thereof except that the optical disc 30 includes a laminate of three or more recording layers.

### Twelfth Embodiment

A twelfth embodiment of this invention is similar to the first to eleventh embodiments thereof except for design changes described hereafter.

According to the twelfth embodiment of this invention, the control program for the optical-disc drive apparatus 20 is initially stored in a recording medium. The recording medium is connected with the optical-disc drive apparatus 20 and is driven therein so that the control program is loaded from the recording medium into the program memory 24.

Alternatively, the control program may be downloaded to the program memory 24 via a transmission line or a communication line.

What is claimed is:

1. An apparatus for recording and reproducing a signal on and from a rewritable optical disc while applying a laser beam from an optical pickup to the optical disc, the optical disc having multiple recording layers among which a recording layer closest to the optical pickup is referred to as the first recording layer, the first recording layer having a data area and a trial write area, the apparatus comprising:
first means for recording user data on the data area in the first recording layer of the optical disc while using the laser beam having a power changing among different values including a first erasing power value;
second means for recording test signals on a section in the trial write area in the first recording layer of the optical disc while using the laser beam having a power changing among different recording power values, and reproducing the recorded test signals from the section in the trial write area; and
third means for performing either a first procedure or a second procedure;
wherein the first procedure illuminates a region in the first recording layer of the optical disc in an initial state with the laser beam having a power equal to a second erasing power value to implement signal erasure with respect to the region in the first recording layer before the second means records and reproduces the test signals on and from the section in the trial write area for the first time, the region including the section in the trial write area, the second erasing power value being equal to the first erasing power value multiplied by a coefficient in the range of 1.5 to 3; and
wherein the second procedure illuminates the section in the trial write area in the first recording layer of the optical disc in the initial state with the laser beam having a power equal to the second erasing power value to implement signal erasure with respect to the section in the trial write area after the second means records and reproduces the test signals on and from the section in the trial write area only once.

2. An apparatus for recording and reproducing a signal on and from a rewritable optical disc while applying a laser beam from an optical pickup to the optical disc, the optical disc having multiple recording layers among which a recording layer closest to the optical pickup is referred to as the first recording layer, the first recording layer having a data area and a trial write area, the apparatus comprising:
first means for recording user data on a zone in the data area in the first recording layer of the optical disc while using the laser beam having a power changing among different values including a first erasing power value;
second means for recording test signals on the trial write area in the first recording layer of the optical disc while using the laser beam having a power changing among different recording power values, and reproducing the recorded test signals from the trial write area; and
third means for performing either a first procedure or a second procedure;
wherein the first procedure illuminates a prescribed region in the data area in the first recording layer of the optical disc in an initial state with the laser beam having a power equal to a second erasing power value to implement signal erasure with respect to the prescribed region in the data area before the first means records the user data on the zone in the data area for the first time, the prescribed region being a predetermined inner-circumference-side region in the data area, the predetermined inner-circumference-side region including the zone in the data area, the second erasing power value being equal to the first erasing power value multiplied by a coefficient in the range of 1.5 to 3; and
wherein the second procedure illuminates the zone in the data area in the first recording layer of the optical disc in the initial state with the laser beam having a power equal to the second erasing power value to implement signal erasure with respect to the zone in the data area after the first means records the user data on the zone in the data area only once.

3. An apparatus as recited in claim 1, further comprising:
fourth means for reading out reference information representative of the coefficient from the optical disc;
a memory storing reference information representative of the coefficient;
fifth means for deriving the coefficient from one of (1) the reference information read out by the fourth means and (2) the reference information stored in the memory; and
sixth means for deciding the second erasing power value on the basis of the first erasing power value and the coefficient derived by the fifth means.

4. An optical information recording medium driven by the apparatus of claim 3, comprising a rewritable optical disc having multiple recording layers among which a recording layer closest to an optical pickup is referred to as the first recording layer, the first recording layer having a pre-pit area and a control data zone, wherein at least one of the pre-pit area and the control data zone prestores the reference information representative of the coefficient.

5. A method of recording and reproducing a signal on and from a rewritable optical disc while applying a laser beam from an optical pickup to the optical disc, the optical disc having multiple recording layers among which a recording layer closest to the optical pickup is referred to as the first recording layer, the first recording layer having a data area and a trial write area, the method comprising the steps of:
(a) recording user data on the data area in the first recording layer of the optical disc while using the laser beam having a power changing among different values including a first erasing power value;
(b) recording test signals on a section in the trial write area in the first recording layer of the optical disc while using the laser beam having a power changing among different recording power values, and reproducing the recorded test signals from the section in the trial write area; and
(c) performing either a first procedure or a second procedure;
wherein the first procedure illuminates a region in the first recording layer of the optical disc in an initial state with the laser beam having a power equal to a second erasing power value to implement signal erasure with respect to the region in the first recording layer before the step (b) records and reproduces the test signals on and from the section in the trial write area for the first time, the region including the section in the trial write area, the second erasing power value being equal to the first erasing power value multiplied by a coefficient in the range of 1.5 to 3; and
wherein the second procedure illuminates the section in the trial write area in the first recording layer of the optical disc in the initial state with the laser beam having a power equal to the second erasing power value to implement signal erasure with respect to the section in the trial write area after the step (b) records and reproduces the test signals on and from the section in the trial write area only once.

6. A method of recording and reproducing a signal on and from a rewritable optical disc while applying a laser beam from an optical pickup to the optical disc, the optical disc having multiple recording layers among which a recording layer closest to the optical pickup is referred to as the first recording layer, the first recording layer having a data area and a trial write area, the method comprising the steps of:
(a) recording user data on a zone in the data area in the first recording layer of the optical disc while using the laser beam having a power changing among different values including a first erasing power value;
(b) recording test signals on the trial write area in the first recording layer of the optical disc while using the laser beam having a power changing among different recording power values, and reproducing the recorded test signals from the trial write area; and
(c) performing either a first procedure or a second procedure;
wherein the first procedure illuminates a prescribed region in the data area in the first recording layer of the optical disc in an initial state with the laser beam having a power equal to a second erasing power value to implement signal erasure with respect to the prescribed region in the data area before the step (a) records the user data on the zone in the data area for the first time, the prescribed region being a predetermined inner-circumference-side region in the data area, the predetermined inner-circumference-side region including the zone in the data area, the second erasing power value being equal to the first erasing power value multiplied by a coefficient in the range of 1.5 to 3; and
wherein the second procedure illuminates the zone in the data area in the first recording layer of the optical disc in the initial state with the laser beam having a power equal to the second erasing power value to implement signal erasure with respect to the zone in the data area after the step (a) records the user data on the zone in the data area only once.

7. A method as recited in claim 5, further comprising the steps of:
(d) reading out reference information representative of the coefficient from the optical disc;
(e) deriving the coefficient from one of (1) the reference information read out by the step (d) and (2) reference information stored in a memory; and
(f) deciding the second erasing power value on the basis of the first erasing power value and the coefficient derived by the step (e).
